(19) United States
(12) Patent Application Publication
(10) Pub. No.: US 2012/0177798 A1
(43) Pub. Date: Jul. 12, 2012

(54) Omega-3 Fatty Acid Enriched Shortenings and Nut Butters

(75) Inventors: Jane Whittinghill, Florissant, MO (US); David Welsby, Stockport Cheshire (GB); Beata E. Lambach, St. Louis, MO (US); Candice Lucak, St. Louis, MO (US)

(73) Assignee: Solae, LLC, St. Louis, MO (US)

(21) Appl. No.: 13/496,556

(22) PCT Filed: Sep. 30, 2010
(86) PCT No.: PCT/US10/50847

§ 371 Date: Mar. 16, 2012

Related U.S. Application Data
(60) Provisional application No. 61/247,267, filed on Sep. 30, 2009.

(51) Int. Cl. A23D 9/00; A23D 7/06; A21D 13/00; A23L 1/38; A21D 13/08; A23G 3/40; A23D 7/00; A23L 1/36; A23D 9/06; A21D 10/00

(52) U.S. Cl. 426/541; 426/606; 426/442; 426/549; 426/556; 426/660; 426/603; 426/607; 426/601; 426/633

(57) ABSTRACT

The present invention relates to compositions and methods for producing shortening compositions and nut butters with a quantity of omega-3 fatty acids (n-3 PUFAs). Specifically, the shortening compositions and nut butters comprise a quantity of stearidonic acid (SDA) enriched soybean oil that imparts improved nutritional quality with a quantity of n-3 PUFAs, but retains the mouthfeel, flavor, odor, and other sensory characteristics associated with typical shortening compositions and nut butters.

### PRIORITY INFORMATION

This application claims priority from Provisional Application Ser. No. 61/247,267 filed on Sep. 30, 2009, which is hereby incorporated by reference in its entirety.

### FIELD OF THE INVENTION

The present invention generally relates to shortening compositions with an amount of polyunsaturated fatty acids and the method of making such compositions. More specifically, the invention is to shortening compositions or nut butters that can be used by a consumer or in an industrial setting for the preparation of food products, or baked food products, that comprise a quantity of stearidonic acid enriched (SDA) soybean oil and the method of making the compositions. The shortening compositions or nut butters possess improved nutritional qualities through the use of the SDA enriched soybean oil in the shortening compositions or nut butters. The use of the SDA enriched shortenings will impart a quantity of omega-3 polyunsaturated fatty acids (n-3 PUFAs) into the food product which includes the shortening.

### BACKGROUND OF THE INVENTION

Recent dietary studies have suggested that certain types of fats are beneficial to body functions and improved health. The use of dietary fats is associated with a variety of therapeutic and preventative health benefits. Current research has demonstrated that the consumption of foods rich in n-3 PUFAs and especially omega-3 long chain polyunsaturated fatty acids (n-3 LC PUFAs), such as eicosapentaenoic acid (EPA; 20:5, n-3) and docosahexaenoic acid (DHA; 22:6, n-3) decreases cardiovascular death by positively impacting a number of markers, such as decreasing plasma triglycerides and blood pressure, and reducing platelet aggregation and inflammation. Typically, n-3 PUFAs, including n-3 LC PUFAs, are derived from plant or marine sources. Marine oils, found in fatty fish, are an important dietary source of the n-3 PUFAs, such as EPA and DHA. While fatty fish may be the best source of these n-3 PUFAs, many individuals do not like the taste of such seafood, do not have ready access to such seafood, or cannot afford such seafood. One solution is to supplement the diet with cod liver oil or fish oil capsules, but many people find the large capsules (ca. 1 g each) difficult to consume, and so this solution has limited compliance. Another solution is to add n-3 PUFAs rich fish oils directly to foods, or ingredients that are used to produce a food product such as spreads, butters, margarines, shortenings or nut butters.

A challenge with the latter approach is to provide the benefits of n-3 PUFAs without imparting any offending fish flavors or fish odors, which develop as a consequence of lipid oxidation. Currently, shortenings may be found in the marketplace that include a quantity of n-3 PUFAs derived from flax, used either as full-fat flour or as oil, both providing α-linolenic acid (ALA; 18:3 n-3), marine based sources, such as fish oil, or from land-based algal sources produced by fermentation, typically DHA in this case. These ingredients contribute a significant quantity of n-3 PUFAs, but these sources of n-3 PUFAs are typically unstable, are especially susceptible to rapid oxidation, and produce unpleasant off flavors, typically described as fishy or painty. Consequently, in current products containing n-3 PUFAs from these sources, the levels of inclusion are very low and generally insufficient to have the desired health impact found at higher dietary levels of use. Because of the generally high temperature and other extreme processing conditions, such as baked goods or other confection compositions the shortening must endure a wide array of extreme conditions. The unstable n-3 PUFAs found in the marine or algal derived sources produce highly undesirable fishy or painty off-flavors and odors when developing/processing/storing the shortening compositions, or when the shortening is used as a baking ingredient by the consumer or in an industrial setting. Therefore, there is a need for a process and the resultant shortening compositions that include a physiologically significant quantity of n-3 PUFAs, that when included with shortening compositions that are then prepared and processed under normal conditions do not produce fishy or unacceptable flavors or odors in the final products. And further it is desired to have a shortening composition that can add n-3 PUFAs into the food product it is used in as an ingredient.

Additionally, it is possible to consume certain plant derived food products or supplements that contain n-3 PUFAs. These plant derived n-3 PUFAs often consist of α-linolenic acid (ALA; 18:3, n-3). ALA is susceptible to oxidation, which results in “painty” off-odors. Moreover, the bioconversion of ALA to n-3 LC PUFAs (specifically EPA) is relatively inefficient. Thus there is a need for forms of n-3 PUFAs that provide the benefits of ready conversion to n-3 LC PUFAs, as well as oxidative stability in foods. Additionally, there is a need for a process and the resultant shortening composition that includes a quantity of stable n-3 PUFAs that are readily metabolized to n-3 LCPUFAs. As previously stated, the plant derived n-3 PUFAs (ALA) are also susceptible to oxidization and can impart offensive painty odors and tastes when exposed to extreme processing steps and the processing environment or subsequent use as an ingredient in a food composition or baked food composition. Therefore, there is a need for a process and resultant shortening compositions, such as margarines, that include a quantity of n-3 PUFAs, that are stable and do not impart fishy or painty odors or tastes due to oxidation of the n-3-PUFAs during the processing steps, while being transported and/or stored before use and/or consumption. There is also a need for a process and resultant nut butters, such as peanut butter, that include a quantity of n-3 PUFAs, that are stable and do not impart fishy or painty odors or tastes due to oxidation of the n-3-PUFAs during the processing steps, while being transported and/or stored before use and/or consumption.

### SUMMARY OF THE INVENTION

The present invention is a shortening composition such as a shortening composition that includes a quantity of SDA enriched soybean oil. The shortening composition is broadly defined as a liquid, fluid, semi-fluid, semi solid, or pliable solid food product. The SDA enriched soybean oil contains n-3 PUFAs that when incorporated into the shortening composition, provides a clean flavor, longer shelf-life stability, minimal oxidation, stability when exposed to extreme processing conditions, stability when used by a consumer or in an industrial setting as a baking ingredient and enhanced nutritional qualities when compared to other sources of n-3 PUFAs. Further, the shortening compositions with the SDA enriched soybean oil possess similar taste, mouthfeel, odor, flavor, and sensory properties when compared to shortening products made from conventional oils, such as soybean oil, but with increased nutritional values.

Additionally, the shortening composition may include at least one stabilizing agent such as lecithin. Other stabilizing agents, such as other phospholipids or antioxidants, can be combined with the SDA enriched soybean oil for incorporation into the shortening product. The incorporation of the at least one stabilizing agent produces a shortening composition that possess similar taste, mouthfeel, odor, flavor, and sensory properties when compared to products made from conventional oils, such as soybean oil, but with increased nutritional values, and further has enhanced storage and shelf stability as well as enhanced baking characteristics when used as an ingredient in food products.

The present invention is also directed to a method of using SDA enriched soybean oil and at least one stabilizing agent to produce a shortening composition that has enhanced nutritional qualities but similar taste, mouthfeel, odor, flavor, and sensory properties when compared to a typical shortening composition or can be substituted for shortenings used in the industry or by consumers to create food products.

The current invention demonstrates a process, composition, end product, and method of using SDA enriched shortening compositions that possess certain nutritional and beneficial qualities for a consumer and have enhanced storage and shelf stability. But the shortening compositions also have similar taste, mouthfeel, odor, and flavor as that found in typical shortening compositions desired by consumers.

The present invention is further to a nut butter such as a nut butter that includes a quantity of SDA enriched soybean oil. Typically, the nut butters are used as spreads. The SDA enriched soybean oil contains n-3 PUFAs that when incorporated into the nut butter, provides a clean flavor, longer shelf-life stability, minimal oxidation, stability when exposed to extreme processing conditions, stability when used by a consumer as a baking ingredient and enhanced nutritional qualities when compared to other sources of n-3 PUFAs. Further, the nut butters with the SDA enriched soybean oil possess similar taste, mouthfeel, odor, flavor, and sensory properties when used as a spread when compared to nut butters made from conventional oils, such as soybean oil, but with increased nutritional values.

Additionally, the nut butter may include at least one stabilizing agent such as lecithin. Other stabilizing agents, such as other phospholipids or antioxidants, can be combined with the SDA enriched soybean oil for incorporation into the nut butter. The incorporation of the at least one stabilizing agent produces a nut butter that possess similar taste, mouthfeel, odor, flavor, and sensory properties when compared to products made from conventional oils, such as soybean oil, but with increased nutritional values, and further has enhanced storage and shelf stability as well as enhanced baking characteristics when used as an ingredient in food products.

Further, the nut butters may include a quantity of protein such as soy protein, pea protein, milk protein, rice protein, collagen, and combinations thereof. The nut butters containing protein may include at least one stabilizing agent.

The present invention is also directed to a method of using SDA enriched soybean oil and at least one stabilizing agent to produce a nut butter that has enhanced nutritional qualities but similar taste, mouthfeel, odor, flavor, and sensory properties when compared to a typical nut butters or can be substituted for nut butters used in the industry or by consumers to create food products.

The current invention demonstrates a process, composition, end product, and method of using SDA enriched nut butters that possess certain nutritional and beneficial qualities for a consumer and have enhanced storage and shelf stability. But the nut butters also have similar taste, mouthfeel, odor, and flavor as that found in typical nut butters desired by consumers.

### DESCRIPTION OF FIGURES

FIG. 1 graphically illustrates the sensory profiling of chocolate chip cookies flavor, texture, and aftertaste differences based on Soybean Oil Shortening and SDA Oil Shortening. The black dashed line marks the Recognition Threshold Level.

FIG. 2 summarizes consumer acceptance ratings for chocolate chip cookies prepared with Soybean Oil Shortening and SDA Oil Shortening.

FIG. 3 graphically illustrates the sensory profiling of dark chocolate compound coating bars flavor and aftertaste differences based on Soybean Oil Shortening and SDA Oil Shortening. The black dashed line marks the Recognition Threshold Level.

FIG. 4 summarizes consumer acceptance ratings for dark chocolate compound coating bars prepared with Soybean Oil Shortening and SDA Oil Shortening.

FIG. 5 graphically illustrates the sensory profiling of lemon danish flavor and aftertaste differences based on Soybean Oil Shortening and SDA Oil Shortening. The black dashed line marks the Recognition Threshold Level.

FIG. 6 summarizes consumer acceptance ratings for lemon danish prepared with Soybean Oil Shortening and SDA Oil Shortening.

FIG. 7 graphically illustrates the sensory profiling of vanilla icing flavor and aftertaste differences based on Soybean Oil Shortening and SDA Oil Shortening. The black dashed line marks the Recognition Threshold Level.

FIG. 8 summarizes consumer acceptance ratings for vanilla icing prepared with Soybean Oil Shortening and SDA Oil Shortening.

### DETAILED DESCRIPTION OF THE INVENTION

The present invention relates to a method of using SDA enriched soybean oil for producing shortening compositions or nut butters, and the resultant shortening compositions or nut butters with an increased nutritional value for consumption by consumers, or as a food ingredient to improve consumers' health. Further, the invention is to shortening compositions with increased nutritional values that include a quantity of n-3 PUFAs but retain the mouthfeel, flavor, odor, and other sensory characteristics of typical shortening compositions that consumers desire or the shortening composition can be used as an ingredient to produce nutritionally enhanced food products. The invention also covers nut butters with increased nutritional values that include a quantity of n-3 PUFAs but retain the mouthfeel, flavor, odor, and other sensory characteristics of typical nut butters that consumers desire or the nut butter can be used as an ingredient to produce nutritionally enhanced food products.

Uses of PUFAs and especially n-3 PUFAs in shortening compositions are typically limited by their lack of oxidative stability. Because of the harsh processing conditions for producing shortening compositions, and the extreme uses of the shortening in the industry and by a consumer to produce food products and baked food products n-3 PUFAs are oxidized. The processing conditions that shortenings must under go cause n-3 PUFAs to readily oxidize and produce off flavors in the shortening compositions or food products that include a quantity of the shortening composition. By using a type of n-3 PUFAs that is oxidatively stable during mixing, processing, and packaging phases and during storage, transport, shelf life, and cooking by the consumer a shortening composition is produced that not only retains the mouthfeel, flavor, odor, and other characteristics typical shortening compositions posses but also has increased nutritional value and can be used as an ingredient in the creation of other food products.

Uses of PUFAs and especially n-3 PUFAs in nut butters are typically limited by their lack of oxidative stability. Because of the harsh processing conditions for producing nut butters and the extreme uses of the nut butters by a consumer to produce food products and baked food products n-3 PUFAs are oxidized. The processing conditions that nut butters must under go cause n-3 PUFAs to readily oxidize and produce off flavors in the nut butters or food products that include a quantity of the nut butter. By using a type of n-3 PUFAs that is oxidatively stable during mixing, processing, and packaging phases and during storage, transport, shelf life, and cooking by the consumer a nut butter is produced that not only retains the mouthfeel, flavor, odor, and other characteristics typical nut butters posses but also has increased nutritional value and can be used as an ingredient in the creation of other food products.

### (I) Compositions

(a) Shortenings

One aspect of the present invention is a shortening composition that comprises a quantity of n-3 PUFAs. The n-3 PUFAs are incorporated into the shortening compositions through the use of SDA enriched soybean oil. In one embodiment the SDA enriched soybean oil is obtained from soybeans that are engineered to produce high levels of stearidonic acid (SDA), such as those described in WO2008/085840 and WO2008/085841. The soybeans can be processed according to the extraction method consistent with those methods described in US Patent Application 2006/0111578 and 2006/0111254. In another embodiment oil obtained from other plant sources with elevated SDA, such as but not limited to Echium spp, Buglossoides spp, and blackcurrant oil can be used.

The shortening composition will include an amount of a hard fat source. The hard fat source can be from any source currently used in the industry, including but not limited to vegetable oils such as palm oil, palm kernel oil, cottonseed oil, coconut oil, sunflower oil, soybean oil, high stearic oil; all types of animal fats, such as lard and tallow; and combinations thereof. In one embodiment the hard fat source can be a fully hydrogenated low trans fat. In another embodiment the hard fat source can be a partially hydrogenated low trans fat.

In another embodiment, the shortening composition may further include at least one stabilizing agent, such as an antioxidant. Antioxidants include but are not limited to synthetic antioxidants, natural antioxidants, phospholipids and combinations thereof. Antioxidants stabilize the oxidizable material and thus reduce its oxidation. The concentration of the at least one stabilizing agent will generally range from less than 0.01% to about 65% by weight of the SDA enriched soybean oil. The at least one stabilizing agent can be added at a variety of places during the process of making the compositions. The at least one stabilizing agent may be added directly to the SDA enriched soybean oil. The at least one stabilizing agent may be added to the composition to which the SDA enriched soybean oil is added. Finally, the at least one stabilizing agent could be added both directly to the SDA enriched soybean oil and the composition containing the SDA enriched soybean oil. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Common antioxidants include tocopherols, ascorbyl palmitate, ascorbic acid, and rosemary extract. Phospholipids include but are not limited to lecithin. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linoleic acid (18:2, an n-6), and alpha-linolenic acid (18:3, an n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be a mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae, LLC (St. Louis, Mo.). The soy lecithin may be SOLEC®F, a dry, de-oiled, non-enzyme modified preparation containing about 97% phospholipids. The soy lecithin may be SOLEC® 8160, a dry, de-oiled, enzyme-modified preparation containing about 97% phospholipids. The soy lecithin may be SOLEC® 8120, a dry, de-oiled, hydroxylated preparation containing about 97% phospholipids. The soy lecithin may be SOLEC® 8140, a dry, de-oiled, heat resistant preparation containing about 97% phospholipids. The soy lecithin may be SOLEC®R, a dry, de-oiled preparation in granular form containing about 97% phospholipids.

The ratio of the at least one antioxidant to the SDA enriched soybean oil will vary depending upon the nature of the SDA enriched soybean oil and the antioxidant preparation. In particular, the concentration of antioxidant will be of a sufficient amount to prevent the oxidation of the SDA enriched soybean oil. The concentration of the antioxidant will generally range from less than 0.01% to about 65% by weight of the SDA enriched soybean oil. In one embodiment, the concentration of the antioxidant may range from about 2% to about 50% by weight of the SDA enriched soybean oil. In another embodiment, the concentration of the antioxidant may range from about 2% to about 10% by weight of the SDA enriched soybean oil. In an alternative embodiment, the concentration of the antioxidant may range from about 10% to about 20% by weight of the SDA enriched soybean oil. In yet another embodiment, the concentration of the antioxidant may range from about 20% to about 30% by weight of the oxidizable material. In still another embodiment, the concentration of the antioxidant may range from about 30% to about 40% by weight of the SDA enriched soybean oil. In another alternative embodiment, the concentration of the antioxidant may range from about 40% to about 50% by weight of the SDA enriched soybean oil. In another embodiment, the concentration of the antioxidant may range from about 15% to about 35% by weight of the SDA enriched soybean oil. In another embodiment, the concentration of the antioxidant may range from about 25% to about 30% by weight of the SDA enriched soybean oil.

The shortening compositions may comprise at least one additional antioxidant that is not a phospholipid or a lecithin. The additional antioxidant may further stabilize the SDA enriched soybean oil. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Preferred antioxidants include tocopherols, ascorbyl palmitate, ascorbic acid, and rosemary extract. The concentration of the additional antioxidant or combination of antioxidants may range from about 0.001% to about 5% by weight, and preferably from about 0.01% to about 1% by weight.

(b) Nut Butters

One aspect of the present invention is a nut butter that comprises a quantity of n-3 PUFAs. The n-3 PUFAs are incorporated into the nut butters through the use of SDA enriched soybean oil. In one embodiment the SDA enriched soybean oil is obtained from soybeans that are engineered to produce high levels of stearidonic acid (SDA), such as those described in WO2008/085840 and WO2008/085841. The soybeans can be processed according to the extraction method consistent with those methods described in US Patent Application 2006/0111578 and 2006/0111254. In another embodiment oil obtained from other plant sources with elevated SDA, such as but not limited to Echium spp, Buglossoides spp, and blackcurrant oil can be used.

The nut butter will include an amount of a hard fat source. The hard fat source can be from any source currently used in the industry, including but not limited to vegetable oils such as palm oil, palm kernel oil, cottonseed oil, coconut oil, sunflower oil, soybean oil, high stearic oil; all types of animal fats, such as lard and tallow; and combinations thereof. In one embodiment the hard fat source can be a fully hydrogenated low trans fat. In another embodiment the hard fat source can be a partially hydrogenated low trans fat.

In another embodiment soy flour can be used that is enriched with SDA, either from SDA enriched soybeans or through other processes known in the industry. The SDA enriched soy flour is produced according to typical processes known in the industry, with the SDA enriched soy flour used to replace current soy flour or other flours and ingredients during the production of the nut butters. The resultant product is a nut butter with the desired nutritional characteristics that retains the mouthfeel, flavor, odor, and other sensory characteristics of typical shortening compositions.

The nut butters may include an additional quantity of a protein such as soy protein, pea protein, milk protein, rice protein, collagen, and combinations thereof. The nut butter containing protein may also include at least one stabilizing agent.

In another embodiment, the nut butter may further include at least one stabilizing agent, such as an antioxidant. Antioxidants include but are not limited to synthetic antioxidants, natural antioxidants, phospholipids and combinations thereof. Antioxidants stabilize the oxidizable material and thus reduce its oxidation. The concentration of the at least one stabilizing agent will generally range from less than 0.01% to about 65% by weight of the SDA enriched soybean oil. The at least one stabilizing agent can be added at a variety of places during the process of making the compositions. The at least one stabilizing agent may be added directly to the SDA enriched soybean oil. The at least one stabilizing agent may be added to the composition to which the SDA enriched soybean oil is added. Finally, the at least one stabilizing agent could be added both directly to the SDA enriched soybean oil and the composition containing the SDA enriched soybean oil. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Common antioxidants include tocopherols, ascorbyl palmitate, ascorbic acid, and rosemary extract. Phospholipids include but are not limited to lecithin. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linoleic acid (18:2, an n-6), and alpha-linolenic acid (18:3, an n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be a mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae, LLC (St. Louis, Mo.). The soy lecithin may be SOLEC®F, a dry, de-oiled, non-enzyme modified preparation containing about 97% phospholipids. The soy lecithin may be SOLEC® 8160, a dry, de-oiled, enzyme-modified preparation containing about 97% phospholipids. The soy lecithin may be SOLEC® 8120, a dry, de-oiled, hydroxylated preparation containing about 97% phospholipids. The soy lecithin may be SOLEC® 8140, a dry, de-oiled, heat resistant preparation containing about 97% phospholipids. The soy lecithin may be SOLEC®R, a dry, de-oiled preparation in granular form containing about 97% phospholipids.

The ratio of the at least one antioxidant to the SDA enriched soybean oil will vary depending upon the nature of the SDA enriched soybean oil and the antioxidant preparation. In particular, the concentration of antioxidant will be of a sufficient amount to prevent the oxidation of the SDA enriched soybean oil. The concentration of the antioxidant will generally range from less than 0.01% to about 65% by weight of the SDA enriched soybean oil. In one embodiment, the concentration of the antioxidant may range from about 2% to about 50% by weight of the SDA enriched soybean oil. In another embodiment, the concentration of the antioxidant may range from about 2% to about 10% by weight of the SDA enriched soybean oil. In an alternative embodiment, the concentration of the antioxidant may range from about 10% to about 20% by weight of the SDA enriched soybean oil. In yet another embodiment, the concentration of the antioxidant may range from about 20% to about 30% by weight of the oxidizable material. In still another embodiment, the concentration of the antioxidant may range from about 30% to about 40% by weight of the SDA enriched soybean oil. In another alternative embodiment, the concentration of the antioxidant may range from about 40% to about 50% by weight of the SDA enriched soybean oil. In another embodiment, the concentration of the antioxidant may range from about 15% to about 35% by weight of the SDA enriched soybean oil. In another embodiment, the concentration of the antioxidant may range from about 25% to about 30% by weight of the SDA enriched soybean oil.

The nut butters may comprise at least one additional antioxidant that is not a phospholipid or a lecithin. The additional antioxidant may further stabilize the SDA enriched soybean oil. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Preferred antioxidants include tocopherols, ascorbyl palmitate, ascorbic acid, and rosemary extract. The concentration of the additional antioxidant or combination of antioxidants may range from about 0.001% to about 5% by weight, and preferably from about 0.01% to about 1% by weight.

### (II) Method of Using and Processes for Forming the Compositions

(a) Shortening Compositions

Production of the n-3 PUFAs enriched shortening compositions are accomplished by replacing a quantity of the typical hard fat ingredient or vegetable oil ingredient with SDA enriched soybean oil to produce the shortening compositions. In another embodiment, SDA enriched soybean oil can replace part of the existing fat or oil in an application or can be added additionally to those products that are naturally or formulated to be low in fat. In one embodiment, the SDA enriched soybean oil will replace all the hard fat or vegetable oil used to produce the desired shortening composition. In an alternative embodiment, the SDA enriched soybean oil will replace an amount of the hard fat or vegetable oil used in the shortening compositions production, to produce an end product that contains a sufficient amount of n-3 PUFA as recommended by the industry. The general consensus in the omega-3 research community is for a consumer to consume around 400-500 mg/day of EPA/DHA equivalent (Harris et al. (2009) J. Nutr. 139:804 S-819S). Typically a consumer will consume four (4) 100 mg/serving per day to ultimately consume 400 mg/day.

The shortening compositions are generally formed dependent on the desired end product. The shortening compositions are produced according to standard industry recipes except the fat or oil ingredient typically used is partially or totally replaced with the SDA enriched soybean oil. The amount of SDA enriched soybean oil used will vary from about 5% to 95% and is dependent on the end product and the nutritional value or amount of n-3 PUFAs desired in the end product. The shortening composition can be a blend of SDA enriched soybean oil and hard fat. In one embodiment the shortening composition can include approximately 5% to 99% hard fat and between approximately 1% to 95% SDA enriched soybean oil. In one embodiment 5% of the hard fat or oil used in a typical shortening composition is replaced with the SDA enriched soybean oil. In another embodiment 10% of the hard fat or oil used in a typical shortening composition is replaced with the SDA enriched soybean oil. In another embodiment 20% of the hard fat or oil used in a typical shortening composition is replaced with the SDA enriched soybean oil. In another embodiment 25% of the hard fat or oil used in a typical shortening composition is replaced with the SDA enriched soybean oil. In another embodiment 30% of the hard fat or oil used in a typical shortening composition is replaced with the SDA enriched soybean oil. In another embodiment 40% of the hard fat or oil used in a typical shortening composition is replaced with the SDA enriched soybean oil. In another embodiment 50% of the hard fat or oil used in a typical shortening composition is replaced with the SDA enriched soybean oil. In another embodiment 60% of the hard fat or oil used in a typical shortening composition is replaced with the SDA enriched soybean oil. In another embodiment 70% of the hard fat or oil used in a typical shortening composition is replaced with the SDA enriched soybean oil. In another embodiment 75% of the hard fat or oil used in a typical shortening composition is replaced with the SDA enriched soybean oil. In another embodiment 80% of the hard fat or oil used in a typical shortening composition is replaced with the SDA enriched soybean oil. In another embodiment 90% of the hard fat or oil used in a typical shortening composition is replaced with the SDA enriched soybean oil. In another embodiment 95% of the hard fat or oil used in a typical shortening composition is replaced with the SDA enriched soybean oil.

In another embodiment a quantity of at least one stabilizing agent, such as an antioxidant, is added to the shortening composition. In one embodiment, the antioxidant is a lecithin and is combined with the SDA enriched soybean oil, the concentration of the lecithin in the shortening composition is from less than 0.01% to about 65% by weight of the SDA enriched soybean oil, and more typically, from about 15% to about 35% by weight of the SDA enriched soybean oil. In another embodiment, the concentration of the lecithin in the shortening composition is from about 25% to about 30% by weight of the SDA enriched soybean oil. In another embodiment an amount of SDA enriched soybean oil can be added in addition to the hard fat or oil typically used in the shortening composition.

After including a quantity of the SDA enriched soybean oil, hard fat and other ingredients based on the desired end product the shortening composition is then processed according to typical industry recipes. To produce the shortening compositions, no additional processing or ingredients other than those typically used in the industry to produce the shortening compositions are required, although at least one stabilizing agent may be included.

(b) Nut Butters

Production of the n-3 PUFAs enriched nut butters are accomplished by replacing a quantity of the typical hard fat ingredient or vegetable oil ingredient with SDA enriched soybean oil to produce the nut butters. In another embodiment, SDA enriched soybean oil can either replace part or all of the existing fat or oil in an application or can be added additionally to those products that are naturally or formulated to be low in fat. In one embodiment, the SDA enriched soybean oil will replace all the hard fat or vegetable oil used to produce the desired nut butter. In, an alternative embodiment, the SDA enriched soybean oil will replace an amount of the hard fat or vegetable oil used in the nut butters production, to produce an end product that contains a sufficient amount of n-3 PUFA as recommended by the industry. In another embodiment, the SDA enriched soybean oil will be added in addition to the typical amount of hard fat or vegetable oil used in the nut butter. The general consensus in the omega-3 research community is for a consumer to consume around 400-500 mg/day of EPA/DHA equivalent (Harris et al. (2009) J. Nutr. 139:804 S-819S). Typically a consumer will consume four (4) 100 mg/serving per day to ultimately consume 400 mg/day.

The nut butters are generally formed dependent on the desired end product. The nut butters are produced according to standard industry recipes except the fat or oil ingredient typically used is partially or totally replaced with the SDA enriched soybean oil. The amount of SDA enriched soybean oil used will vary from about 1% to 100% and is dependent on the end product and the nutritional value or amount of n-3 PUFAs desired in the end product. The nut butter can be a blend of SDA enriched soybean oil and hard fat. In one embodiment the nut butter can include approximately 1% to 100% hard fat and between approximately 1% to 100% SDA enriched soybean oil. In one embodiment 5% of the hard fat or oil used in a typical nut butter is replaced with the SDA enriched soybean oil. In one embodiment 5% of the hard fat or oil used in a typical shortening composition is replaced with the SDA enriched soybean oil. In another embodiment 10% of the hard fat or oil used in a typical shortening composition is replaced with the SDA enriched soybean oil. In another embodiment 20% of the hard fat or oil used in a typical shortening composition is replaced with the SDA enriched soybean oil. In another embodiment 25% of the hard fat or oil used in a typical shortening composition is replaced with the SDA enriched soybean oil. In another embodiment 30% of the hard fat or oil used in a typical shortening composition is replaced with the SDA enriched soybean oil. In another embodiment 40% of the hard fat or oil used in a typical shortening composition is replaced with the SDA enriched soybean oil. In another embodiment 50% of the hard fat or oil used in a typical shortening composition is replaced with the SDA enriched soybean oil. In another embodiment 60% of the hard fat or oil used in a typical shortening composition is replaced with the SDA enriched soybean oil. In another embodiment 70% of the hard fat or oil used in a typical shortening composition is replaced with the SDA enriched soybean oil. In another embodiment 75% of the hard fat or oil used in a typical shortening composition is replaced with the SDA enriched soybean oil. In another embodiment 80% of the hard fat or oil used in a typical shortening composition is replaced with the SDA enriched soybean oil. In another embodiment 90% of the hard fat or oil used in a typical shortening composition is replaced with the SDA enriched soybean oil. In another embodiment 95% of the hard fat or oil used in a typical shortening composition is replaced with the SDA enriched soybean oil. In another embodiment 100% of the hard fat or oil used in a typical nut butter is replaced with the SDA enriched soybean oil.

In another embodiment a quantity of at least one stabilizing agent, such as an antioxidant, is added to the nut butter. In one embodiment, the antioxidant is a lecithin and is combined with the SDA enriched soybean oil, the concentration of the lecithin in the nut butter is from less than 0.01% to about 65% by weight of the SDA enriched soybean oil, and more typically, from about 15% to about 35% by weight of the SDA enriched soybean oil. In another embodiment, the concentration of the lecithin in the nut butter is from about 25% to about 30% by weight of the SDA enriched soybean oil. In another embodiment an amount of SDA enriched soybean oil can be added in addition to the hard fat or oil typically used in the nut butter.

In a further embodiment, an additional quantity of protein is added to the nut butter. The protein can be any protein known to work in nut butters including but not limited to soy protein, pea protein, milk protein, rice protein, collagen, and combinations thereof. Soy protein that can be incorporated into the nut butter include soy protein isolate, soy protein concentrate, soy flour, and combinations thereof.

### (III) Food Products

(a) Shortening Compositions

A further aspect of the present invention are shortening compositions with n-3 PUFAs incorporated and increased nutritional values, which retain the mouthfeel, flavor, odor, and other sensory characteristics of typical shortening compositions. The shortening compositions will vary depending on the desired end product but can include plastic shortenings, creaming shortenings, cake and pastry shortenings, general purpose shortenings, puff pastry shortenings, puff pastry fats, pourable shortenings, dry shortenings, lards, and combinations thereof. Additional examples include, any shortening products used in commercial and household cooking or used to produce food products not limited to baked food products such as cookies, dough, pastries, breads, or confections, as well as margarines, and butters.

(b) Nut Butters

Another aspect of the present invention is nut butters with n-3 PUFAs incorporated and increased nutritional values, which retain the mouthfeel, flavor, odor, and other sensory characteristics of typical nut butters. The SDA Oil can be added to any nut butter that is currently known. The nut butters of the present invention can be directly consumed by consumers or can be incorporated into baked goods or used in recipes like typical nut butters.

### DEFINITIONS

To facilitate understanding of the invention several terms are defined below.

The term “n-3 PUFAs” refers to omega-3 polyunsaturated fatty acids and includes omega-3 long chain polyunsaturated fatty acids and n-3 LCPUFAs.

The terms “stearidonic acid enriched soybean oil”, “SDA enriched soybean oil”, and “SDA oil” refer to soybean oil that has been enriched with stearidonic acid.

The term “milk” refers to animal milk, plant milk, and nut milk. Animal milk is a white fluid secreted by the mammary glands of female mammals consisting of minute globules of fat suspended in a solution of casein, albumin, milk sugar, and inorganic salts. Animal milk includes but is not limited to milk from cows, goats, sheep, donkeys, camels, camelids, yaks, water buffalos. Plant milk is a juice or sap found in certain plants and includes but is not limited to milk derived from soy, and other vegetables. Nut milk is an emulsion made by bruising seeds and mixing with a liquid, typically water. Nuts that can be used for milk include but are not limited to almonds and cashews.

The term “milk protein” refers to any protein contained in milk as defined above, including any fractions extracted from the milk by any means known in the art. Milk protein further includes any combinations of milk proteins.

The acronym “SBO” denotes soybean oil used as a control in the examples. Such SBO is refined, bleached, and deodorized as used in the food industry.

The acronym “HPKO” denotes hydrogenated palm kernel oil used as a hard fat in the manufacture of shortening

The term “shortening” refers to any emulsified or non emulsified fat from animal or vegetable source used in bakery application. The term SDA enriched shortening refers to shortenings containing SDA oil.

The term “hard fat” as used herein, refers to a fat that consists mainly of saturated fatty acids with high melting points.

The term “plastic shortening” refers to solid fat with fat crystals that hold liquid oil, thus imparting plasticity to a food product.

The term “pourable” or “liquid” shortenings refer to fluid suspensions of a hard fat or a high melting emulsifier dispersed in liquid oil.

The term “dry” or “powdered” or “flake” shortenings refers to shortening beads, flakes or powders composed of high-melting solidified edible oil products in these form for ease of bulk metering and handling.

The term “spreads” refers to fat and/or oil blended with other ingredients such as water and/or milk products, proteins, salt, flavoring, coloring and vitamins.

The term “nut butter” refers to a high fat spreadable paste made by crushing nuts and containing other ingredients including fats and/or oils. Nut butters include but are not limited to peanut butter, almond butter, chocolate hazelnut spread, and cashew butter.

The term “puff pastry shortening” refers to a shortening that has a wide melting point range and a high solid fat content and is used to make pastries and pastry type food products.

The following examples are used herein to illustrate different aspects of this invention and are not meant to limit the present invention in any way. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

### EXAMPLES

### Example 1

### Shortening Compositions

Example 1 provides detailed recipes for producing shortening compositions. The variations within Example 1 include 1) the amount of SDA enriched soybean oil vs. regular soybean oil used as an ingredient in the shortening composition, 2) the temperature the hard fat was melted and brought up to before the addition of the SDA enriched soybean oil or regular soybean oil, and 3) the mixing temperature used when combining the ingredients. Table 1 lists the formulations of the different shortening blends.

TABLE 1
Shortening Formulations containing SDA

| | Ingredients | | | | | | | | | | | | | |
|---|---|---|---|---|---|---|---|---|---|---|---|---|---|---|
| | 80:20 | 80:20 | 70:30 | 70:30 | 60:40 | 60:40 | 50:50 | 50:50 | 40:60 | 40:60 | 30:70 | 30:70 | 20:80 | 20:80 |
| | SBO | SDA | SBO | SDA | SBO | SDA | SBO | SDA | SBO | SDA | SBO | SDA | SBO | SDA |
| HPKO | 1280.0 | 1280.0 | 1120.0 | 1120.0 | 960.0 | 960.0 | 800.0 | 800.0 | 640.0 | 640.0 | 480.0 | 480.0 | 320.0 | 320.0 |
| SBO | 320.0 | 0.0 | 480.0 | 0.0 | 640.0 | 0.0 | 800.0 | 0.0 | 960.0 | 0.0 | 1120.0 | 0.0 | 1280.0 | 0.0 |
| SDA Oil | 0.0 | 320.0 | 0.0 | 480.0 | 0.0 | 640.0 | 0.0 | 800.0 | 0.0 | 960.0 | 0.0 | 1120.0 | 0.0 | 1280.0 |
| Total | 1600.0 | 1600.0 | 1600.0 | 1600.0 | 1600.0 | 1600.0 | 1600.0 | 1600.0 | 1600.0 | 1600.0 | 1600.0 | 1600.0 | 1600.0 | 1600.0 |

The hard fat (Columbus Foods, Des Plaines, Ill.) was melted slowly and its temperature was brought up to 20° C. to 40° C. in a stainless steel container. The SDA enriched soy oil was added slowly with stirring and the temperature kept between 20° C. to 50° C. for 5 minutes to 10 minutes, Table 2.

The mixture was then chilled at 5° C. to 15° C. with stirring and nitrogen flushing. Chilling was carried out in the stainless steel metal container for 5 minutes to 10 minutes under a stream of nitrogen and packaged.

The product blend was tempered at between 4° C. to 10° C., 10° C. to 20° C. and 20° C. to 30° C. for between 24 hours to 48 hours.

After tempering, the product was stored under refrigeration temperatures.

TABLE 2
Shortening Formulation Process Conditions

| | Ingredients | | | | | | | | | | | | | |
|---|---|---|---|---|---|---|---|---|---|---|---|---|---|---|
| | 80:20 | 80:20 | 70:30 | 70:30 | 60:40 | 60:40 | 50:50 | 50:50 | 40:60 | 40:60 | 30:70 | 30:70 | 20:80 | 20:80 |
| | SBO | SDA | SBO | SDA | SBO | SDA | SBO | SDA | SBO | SDA | SBO | SDA | SBO | SDA |
| Mixing | 5 | 5 | 5 | 5 | 5 | 5 | 10 | 8 | 7 | 7 | 8 | 10 | 18 | 18 |
| (mins) | | | | | | | | | | | | | | |
| Mixing | 40 | 40 | 40 | 40 | 45 | 40 | 40 | 43 | 30 | 35 | 30 | 25 | 35 | 30 |
| Temp. ° C. | | | | | | | | | | | | | | |
| Cooling | 10 | 10 | 10 | 10 | 10 | 10 | 10 | 10 | 10 | 10 | 10 | 10 | 10 | 10 |
| Temp. ° C. | | | | | | | | | | | | | | |

In another embodiment, the shortening blends were manufactured on a pilot scale using Gerstenberg Schroeder (Delavan, Wis.) by combining the palm kernel oil with the SDA enriched soybean oil and heating to 60° C. (140° F.) while stirring.

The oil mixture was then passed through a feed pump with nitrogen injection and through two scraped surface heat exchangers (SSHE) and a pinwheel. The temperature of the first SSHE was set at 22.2° C.-25.6° C. (72-78° F.) and the second SSHE was set at 14.4° C.-23.3° C. (58-74° F.).

The product was filled into 0.45 Kg (1 lb) plastic tubs and tempered at 22° C. for 24 hours to 48 hours.

The product was then refrigerated at 4° C.

### Example 2

### Analysis and Testing of Shortening Blends

The shortening compositions made in Example 1 were analyzed and tested for a number of parameters.

Gas chromatography was used to determine the fatty acid profiles for the shortening. Gas chromatography was conducted according to the AOCS Official Methods Ce 1-62 (1997), Ce 2-66, and Ce 1i-07 (2007). This determines the concentration and type of fatty acids present in the final shortening blend. Table 3 shows the fatty acid profile for SDA soybean oil shortening blends.

TABLE 3
Fatty Acid Analysis (g/100 g) of SDA Shortening Blends

| | 40:60 | 50:50 | 60:40 | 80:20 |
|---|---|---|---|---|
| Fatty Acid Profile | SDA | SDA | SDA | SDA |
| C8:0 | 1.0 | 1.4 | 1.4 | 2.9 |
| C10:0 | 1.3 | 1.5 | 1.7 | 2.6 |
| C12:0 | 17.6 | 21.7 | 24.5 | 35.1 |
| C14:0 | 6.0 | 7.6 | 8.5 | 11.8 |
| C16:0 | 10.4 | 10.9 | 11.4 | 9.1 |
| C18:0 | 8.6 | 10.1 | 11.6 | 13.1 |
| C18:1 | 9.4 | 11.3 | 10.4 | 4.1 |
| C18:2n6 | 14.2 | 12.9 | 11.7 | 4.9 |
| C20:0 | 0.3 | 0.3 | 0.3 | 0.2 |
| C18:3n6 | 3.7 | 3.5 | 3.2 | 1.3 |
| C18:3n3 | 6.0 | 6.0 | 5.0 | 2.0 |
| C18:4n3 | 13.1 | 10.9 | 8.1 | 4.4 |
| C22:0 | 0.2 | 0.2 | 0.2 | 0.2 |
| Others | 8.2 | 1.7 | 2.0 | 8.3 |
| Total | 100.0 | 100.0 | 100.0 | 100.0 |
| Omega 3 Fatty Acids | 19.0 | 16.7 | 13.2 | 6.42 |
| Omega 6 Fatty Acids | 17.9 | 16.4 | 14.9 | 6.2 |
| Saturated Fatty Acids | 43.0 | 49.9 | 48.9 | 70.9 |
| Monounsaturated Fatty Acids | 10.9 | 10.2 | 9.1 | 6.1 |
| Polyunsaturated Fatty Acids | 35.3 | 29.0 | 28.1 | 12.0 |

The following are examples of tests that were carried out for the shortening blends.

The Solid Fat Content (SFC) provides details of the actual % of solid fat at standard temperature ranges as determined using pulsed NMR AOCS Official Method Cd 16b-93. Tables 4 and 5 show the SFC of the SDA shortening blends and control shortening blends, respectively.

TABLE 4
SFC of SDA shortening blends

| % HPKO | % SDA | 10.0° | 21.1° | 26.7° | 33.3° | 37.8° |
|---|---|---|---|---|---|---|
| Oil | Oil | C. | C. | C. | C. | C. |
| 40 | 60 | 33.1 | 14.9 | 5.6 | 1.2 | 0.0 |
| 50 | 50 | 42.6 | 21.9 | 9.7 | 1.6 | 0.0 |
| 60 | 40 | 52.4 | 30.0 | 14.5 | 2.5 | 0.3 |
| 80 | 20 | 71.5 | 50.3 | 26.4 | 5.5 | 0.8 |

TABLE 5
SFC of SBO shortening blends

| | | 10° | 21.1° | 26.7° | 33.3° | 37.8° |
|---|---|---|---|---|---|---|
| % HPKO | % SBO | C. | C. | C. | C. | C. |
| 40 | 60 | 34.0 | 14.4 | 5.4 | 1.2 | 0.0 |
| 50 | 50 | 43.5 | 21.2 | 9.4 | 1.5 | 0.0 |
| 60 | 40 | 52.7 | 29.3 | 13.0 | 2.1 | 0.2 |
| 80 | 20 | 72.6 | 50.2 | 26.2 | 5.9 | 0.8 |

Table 6 shows the iodine value (IV) which is a measure of unsaturation of fats and oils and expressed in terms of the number of centigrams (cg) of iodine absorbed per gram of sample (% iodine absorbed) according to the AOCS Official Method Cd 1d-92. Iodine value was expressed in terms of the number of centrigrams of iodine absorbed per gram of sample (% iodine absorbed), Table 6.

The peroxide value determined the primary products of oxidation of unsaturated fatty acids. Peroxide value was determined by measuring the presence of hydroperoxides in the shortening blend in milliequivalents (meq.) of peroxides per kilogram of fat according to the AOCS Official Method Cd 8b-90, Table 6.

TABLE 6
Iodine values and Peroxide values of
the shortening blends stored at 4° C.

| | Shortening Formulation | | | | | | |
|---|---|---|---|---|---|---|---|
| | 80:20 | 70:30 | 60:40 | 50:50 | 40:60 | 30:70 | 20:80 |
| | SDA | SDA | SDA | SDA | SDA | SDA | SDA |
| Iodine Value (cg/g) | 47.8 | 61.2 | 70.2 | 99.4 | 111.0 | 129.0 | 142.0 |
| PV (Day 0) (meq/kg) | <0.1 | <0.1 | 0.3 | 0.3 | 0.2 | 0.2 | 0.2 |
| PV 1 Month (meq/kg) | 0.5 | 0.5 | 0.9 | 0.7 | 0.3 | 0.4 | 0.4 |
| PV 9 month (meq/kg) | 1.8 | 2.9 | 1.0 | 3.7 | 2.8 | 1.1 | 1.6 |

### Examples of Uses

The shortening blends from this invention can be used in food formulations including but not limited to cookies, pie crusts, pastries, doughnuts, confectioneries, cakes and cake mixes, icings, margarines, biscuits, breads, icings and crackers. The following examples are used herein to illustrate different aspects of this invention. The examples are illustrative and are not meant to limit the present invention in any way.

### Example 3

### Cookie Dough Formulation (Chocolate Chip Cookies)

The following example relates to a method of forming a chocolate chip cookie that contains a quantity of SDA enriched shortening. Table 7 provides the formulation for the cookies.

Flour, baking soda, and salt were added to a small bowl and mixed for 30 seconds forming a flour mixture. Granulated sugar, brown sugar, chocolate chip flavoring and vanilla extract were added to a large mixing bowl and mixed for 30 seconds forming a sugar mixture.

The shortening (soybean oil vs SDA enriched soybean oil) was added to the sugar mixture and blended for 90 seconds. One egg was added to the sugar and shortening mixture and mixed for 30 seconds. A second egg was added and mixed an additional 30 seconds and finally a third egg was added and mixed for 30 seconds to form a moist mixture.

Finally the flour mixture was added to the moist mixture and mixed 90 seconds. Chocolate chips were stirred in with two mixing pulses of 15 seconds each. A rounded tablespoon of cookie dough mixture was placed onto ungreased baking sheets. The cookie dough was then baked in a preheated 191° C. (375° F.) oven for 14 minutes or until golden brown.

The baking sheets were removed from the oven and let stand for 2 minutes, after which the cookies were moved to wire racks to cool completely, approximately 10 minutes to 15 minutes.

TABLE 7
Chocolate Chip Cookie Formulation

| | | 60:40 | 60:40 |
|---|---|---|---|
| Ingredients | % | SBO | SDA |
| Flour | 33.94 | 853.00 | 853.00 |
| Baking Soda | 0.40 | 10.00 | 10.00 |
| Salt | 0.40 | 10.00 | 10.00 |
| Shortening | 11.86 | 298.00 | 298.00 |
| Butter | 5.09 | 128.00 | 128.00 |
| White Sugar | 9.95 | 250.00 | 250.00 |
| Brown Sugar | 9.95 | 250.00 | 250.00 |
| Vanilla | 0.92 | 23.00 | 23.00 |
| 3 Eggs | 6.69 | 168.00 | 168.00 |
| Chocolate Chip Flavoring | 0.40 | 10.00 | 10.00 |
| Chocolate chips | 20.40 | 513.00 | 513.00 |
| Total | 100.00 | 2513.00 | 2513.00 |

The resulting cookies have an increased amount of n-3 PUFAs, but retain the taste, structure, aroma, and mouthfeel of typical cookies currently on the market. A fatty acid profile analysis of the cookies from Example 3 was conducted with the results provided in Table 8. Gas chromatography was used to determine the fatty acid profiles for the shortening. Gas chromatography was conducted according to the AOCS Official Methods Ce 1-62 (1997), Ce 2-66, and Ce 1i-07 (2007).

TABLE 8
Fatty Acid Analysis of Chocolate Chip Cookies

| | 60:40 |
|---|---|
| | SDA |
| % Saturated Fat per 32 g serving size | 4.3 |
| % Monounsaturated Fat per 32 g serving size | 1.4 |
| % Polyunsaturated Fat per 32 g serving size | 0.9 |
| % Total n-3 PUFAs per 32 g serving size | 0.4 |
| % Total Omega-6 Fatty Acids per 32 g serving size | 0.6 |

### Example 4

### Sensory Profiling of Chocolate Chip Cookies

Sensory descriptive analysis was conducted on chocolate chip cookies to understand the attribute differences of Soybean Oil shortening and SDA Oil shortening in chocolate chip cookies. Seven panelists trained in the Sensory Spectrum™ Descriptive Profiling method evaluated the samples for 28 flavor attributes, 4 texture attributes, and 3 aftertaste attributes. The attributes were evaluated on a 15-point scale, with 0=none/not applicable and 15=very strong/high in each sample. Definitions of the flavor attributes are given in Table 9 and definitions of the texture attributes are given in Table 10.

Each panelist was given one cookie and were instructed to take a bite. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 9
Flavor Attribute Lexicon

| Attribute | Definition | References | |
|---|---|---|---|
| | | Intensities based on | |
| | | Universal Scale | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| Aromatics | | | |
| Overall Flavor Impact | The overall intensity of the product | | |
| | aromas, an amalgamation of all | | |
| | perceived aromatics, basic tastes and | | |
| | chemical feeling factors. | | |
| Chocolate Complex | The general category used to | | |
| | describe the aromatics associated | | |
| | with chocolate | | |
| Straw/hay/burlap | The aromatic associated with straw, | Straw or burlap bag | |
| | hay and burlap bags. | | |
| Dark roasted | The aromatic associated with dark | Dark roasted nuts, coffee grounds | |
| | roasted nutmeat and having a very | | |
| | browned or toasted characteristic | | |
| Alkali | The aromatic associated with | Baking cocoa mixed with baking | |
| | alkalized cocoa | soda | |
| SWA Complex | The general category of aromatics | Vanilla, molasses, honey, etc. | |
| | associated with sweet foods. | | |
| carmelized | The aromatics associated with | Caramelized sugar | |
| | browned sugars such as caramel. | | |
| Vanilla/Vanillin | The aromatics associated with | Vanilla Extract, Vanillin crystals | |
| | vanilla,. | | |
| Lactone | The sweet, tropical, nutty aromatic | Cocoa butter, imitation coconut | |
| | associated with meat or milk from | flavor, crayons, milk or meat from a | |
| | coconut, including artificial vanilla, | coconut, lanolin, coconut suntan oil | |
| | woody, and browned notes | | |
| Fishy/Pondy Complex | The aroma/aromatics associated with | | |
| | triethylamine, pond water or aged | | |
| | fish. The general term used to | | |
| | describe fish meat, which cannot be | | |
| | tied to a specific fish by name. | | |
| Fishy | Aromatic associated with | Cod liver oil capsules, | |
| | trimethylamine and old fish. | trimethylamine, Geisha canned lump | |
| | | crab, oxidized tea bag, dried parsley, | |
| | | tuna in a pouch | |
| Pondy | The aromas and aromatics associated | Algal oil (Martek 30% DHA oil) | |
| | with water containing algae, | | |
| | reminiscent of pond water and | | |
| | aquatic tanks. | | |
| Nutty | The aromatics associated with a | Most tree nuts; pecans, almonds, | |
| | nutty/woody flavor; also a | hazelnuts, walnuts, (E,Z)-2,4 | |
| | characteristic of walnuts and other | Heptenal, Benzaldehyde. | |
| | nuts, Includes hulls/skins of nuts and | | |
| | benzaldehyde. | | |
| Grain | The aromatics associated with the | All-purpose flour paste, cream of | |
| | total grain impact, which may | wheat, whole wheat pasta | |
| | include all types of grain and | | |
| | different stages of heating. May | | |
| | include wheat, whole wheat, oat, | | |
| | rice, graham, etc | | |
| | | Intensities based on | |
| | | Universal Scale | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| Toasted | The aromatics associated with grains | Wheaties, Corn Flakes, toasted white | |
| | that have been gently heated/or | bread, | |
| | toasted with a nutty, caramelized, | | |
| | browned character of Maillard | | |
| | browned grains. | | |
| Butter/Diacetyl | The clean, fatty, milky flavor of fresh | Sweet cream butter, Diacetyl, Movie- | |
| | butter and/or artificial butter. | theater popcorn | |
| Soy/Legume | The earthy/dirty, green aromatics | Unsweetened Silk, Canned | |
| | associated with legumes/soybeans; | Soybeans, Tofu | |
| | may include all types and different | | |
| | stages of heating. | | |
| Cardboard/Woody | The aromatics associated with dried | Toothpicks, Water from cardboard | |
| | wood and the aromatics associated | soaked for 1hour | |
| | with slightly oxidized fats and oils, | | |
| | reminiscent of a cardboard box. | | |
| Oil Complex | | | |
| Oil, Fresh | An aromatic of unprocessed, | Vegetable oil | |
| | uncooked fruits or vegetables or | | |
| | grain (not cooked) | | |
| Oil, Heated | An aromatic associated with fresh oil | Heated cottonseed oil | |
| | that is heated | | |
| Oil, Overcooked | An aromatic reminiscent of oil | Heated corn oil at 240° C. for 30 | |
| | overheated during processing | minutes. | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

TABLE 10
Texture Attribute Lexicon

| Attribute | Definition | References Scale |
|---|---|---|
| FIRST BITE | | |
| Hardness | The force to attain a given deformation; the force to | 1.0 Cream Cheese |
| | compress between molars. | 4.5 American Cheese |
| | Soft --- Hard | 6.0 Goya Stuffed Olives |
| | | 7.0 Frankfurter |
| | | 9.5 Peanuts |
| | | 11.0 Carrots/Almonds |
| | | 14.5 Hard Candy |
| Cohesiveness | The amount to which the sample deforms rather than | 1.0 Corn Muffin |
| | crumbles, cracks or breaks. | 5.0 American Cheese |
| | Breaks/Crumbles --- Deforms | 8.0 Soft Pretzel |
| | | 11.0-12.0 Candy Chews |
| | | 13.0 Caramel |
| | | 15.0 Chewing Gum |
| Denseness | The compactness of the sample cross-section. | 0.5 Whipped Topping |
| | Alry --- Dense | 2.5 Marshmallow Top |
| | | 2.5 Rice Krispies |
| | | 4.0 Club Crackers |
| | | 6.0 Malted Milk Balls |
| | | 9.0 Frankfurter |
| | | 15.0 Fruit Jelly Candy |
| Crunchiness | The volume (loudness) of the product as it breaks or | 2.0 Chewy Granola Bar |
| | fractures. | 5.0 Vienna Finger |
| | Not Crunchy/Soggy --- Crunchy | 7.0 Pretzel Stick |
| | (Low Volume) --- (High Volume) | 11.0 Ginger Snap |
| | | 13.0 Melba Snack |
| | | 15.0 Corn Nuts |

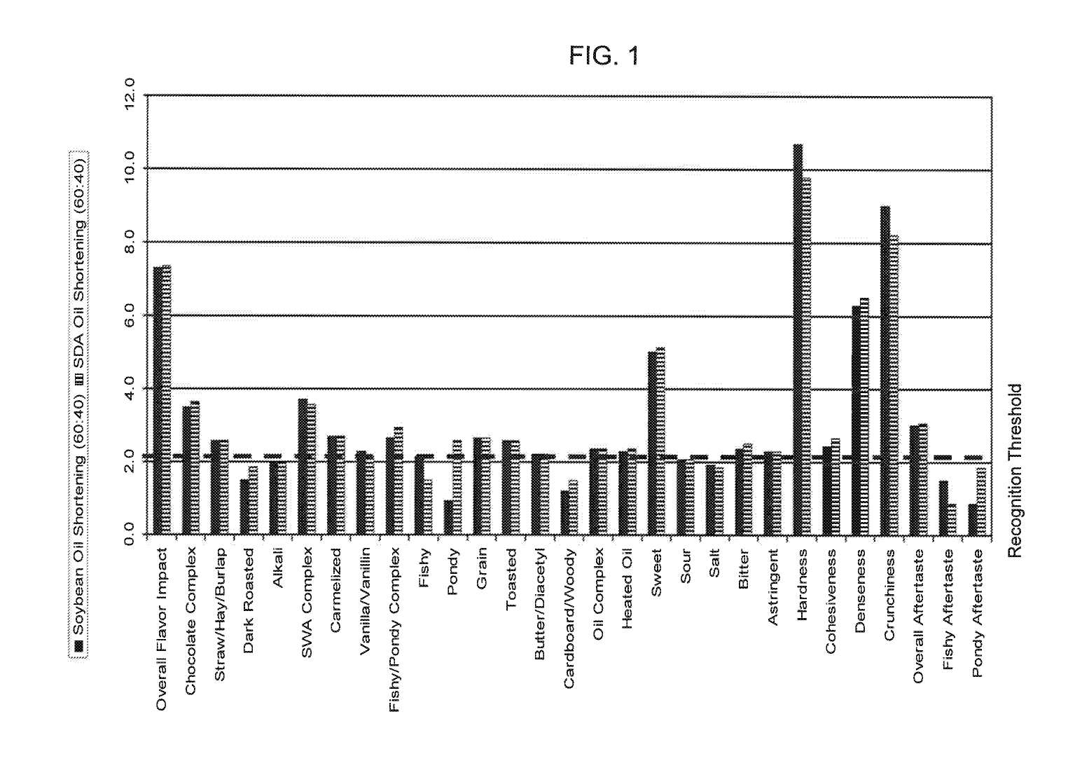

There were detectable differences between the Soybean Oil shortening and SDA Oil shortening in chocolate chip cookies, shown in Tables 11 and 12. The Soybean Oil shortening (60:40) chocolate chip cookie was higher in Vanilla/Vanillin aromatics, Fishy aromatics, Hardness, and Crunchiness (FIG. 1). This sample also had Chemical, Baking Soda, and Ashy aromatics.

The SDA Oil Shortening (60:40) chocolate chip cookie was higher in Dar Roasted aromatics, Fishy/Pondy Complex, Pondy aromatics, Bitter basic taste, Cohesiveness, Denseness, and Pondy Aftertaste (FIG. 1). This sample also had Chemical, Baking Soda, and Ashy aromatics.

Both the Soybean Oil shortening and the SDA Oil shortening chocolate chip cookies had Fishy/Pondy aromatics that were above the recognition threshold (2.0). The 2.6/2.9 intensity of these aromatics is still acceptable. These intensities are just slightly above the intensity of the baking soda note in a saltine cracker (Table 9).

TABLE 11
Mean Scores for Flavor Attributes for
Chocolate Chip Cookies.

| | Soybean Oil | SD A Oil | |
|---|---|---|---|
| | Shortening | Shortening | p |
| | (60:40) | (60:40) | value |
| Aromatics | | | |
| Overall Flavor Impact | 7.3 a | 7.4 a | NS |
| Chocolate Complex | 3.5 a | 3.6 a | * |
| Straw/Hay/Burlap | 2.6 a | 2.6 a | NS |
| Dark Roasted | 1.5 b | 1.9 a | ** |
| Alkali | 2.0 a | 2.0 a | NS |
| SWA Complex | 3.7 a | 3.6 a | * |
| Carmelized | 2.7 a | 2.7 a | NS |
| Vanilla/Vanillin | 2.3 a | 2.1 b | ** |
| Lactone | 0.0 | 0.0 | n/a |
| Fishy/Pondy Complex | 2.6 b | 2.9 a | *** |
| Fishy | 2.1 a | 1.5 b | ** |
| Pondy | 0.9 b | 2.6 a | *** |
| Nutty | 0.0 | 0.0 | n/a |
| Grain | 2.6 a | 2.6 a | NS |
| Toasted | 2.6 a | 2.6 a | NS |
| Butter/Diacetyl | 2.2 a | 2.2 a | NS |
| Soy/Legume | 0.0 | 0.0 | n/a |
| Cardboard/Woody | 1.2 a | 1.5 a | * |
| Oil Complex | 2.4 a | 2.4 a | NS |
| Fresh Oil | 0.0 | 0.0 | n/a |
| Heated Oil | 2.3 a | 2.4 a | * |
| Overcooked Oil | 0.3 b | 0.0 b | * |
| Other Aromatic: | 2.0 (29%) | 2.0 (29%) | |
| Chemical | | | |
| Other Aromatic: Baking | 2.2 (43%) | 2.2 (43%) | |
| Soda | | | |
| Other Aromatic: Ashy | 2.0 (14%) | 2.0 (14%) | |
| Basic Tastes & Feeling | | | |
| Factors | | | |
| Sweet | 5.0 a | 5.1 a | NS |
| Sour | 2.1 a | 2.1 a | NS |
| Salt | 1.9 a | 1.9 a | * |
| Bitter | 2.4 b | 2.5 a | ** |
| Astringent | 2.3 a | 2.3 a | NS |
| Burn | 0.1 a | 0.0 a | * |

¹Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 12
Mean Scores for Texture and Aftertaste Attributes for Chocolate Chip
Cookies

| | Soybean Oil | SD A Oil | |
|---|---|---|---|
| | Shortening | Shortening | |
| | (60:40) | (60:40) | p value |
| Texture | | | |
| Hardness | 10.7 a | 9.8 b | *** |
| Cohesiveness | 2.4 b | 2.6 a | ** |
| Denseness | 6.3 b | 6.5 a | ** |
| Crunchiness | 9.0 a | 8.2 b | *** |
| Aftertaste | | | |
| Overall Aftertaste | 3.0 a | 3.1 a | * |
| Fishy Aftertaste | 1.5 a | 0.9 a | * |
| Pondy Aftertaste | 0.9 b | 1.9 a | *** |

¹Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

### Example 5

### Sensory Acceptance of Chocolate Chip Cookies

To evaluate sensory parity of Soybean Oil shortening and SDA Oil shortening, consumer acceptability based on Soybean Oil shortening and SDA Oil shortening were analyzed for chocolate chip cookies. The acceptance ratings were compared between the Soybean Oil Shortening (60:40) and SDA Oil Shortening (60:40) chocolate chip cookies.

The samples were evaluated by 37 consumers willing to try chocolate chip cookies; prescreened by signing the SDA inform consent. The judges used a 9-point Hedonic acceptance scale. The Hedonic scale ranged from 1 being dislike extremely to 9 being like extremely and was used for Overall Liking, Appearance Liking, Color Liking, Flavor Liking, Texture Liking, and Aftertaste Liking.

Consumers evaluated one cookie. The samples were served by sequential monadic presentation (one at a time).

The data was analyzed using the Analysis of Variance (ANOVA) to account for panelist and sample effects, with mean separations using Tukey's Significant Difference (HSD) Test.

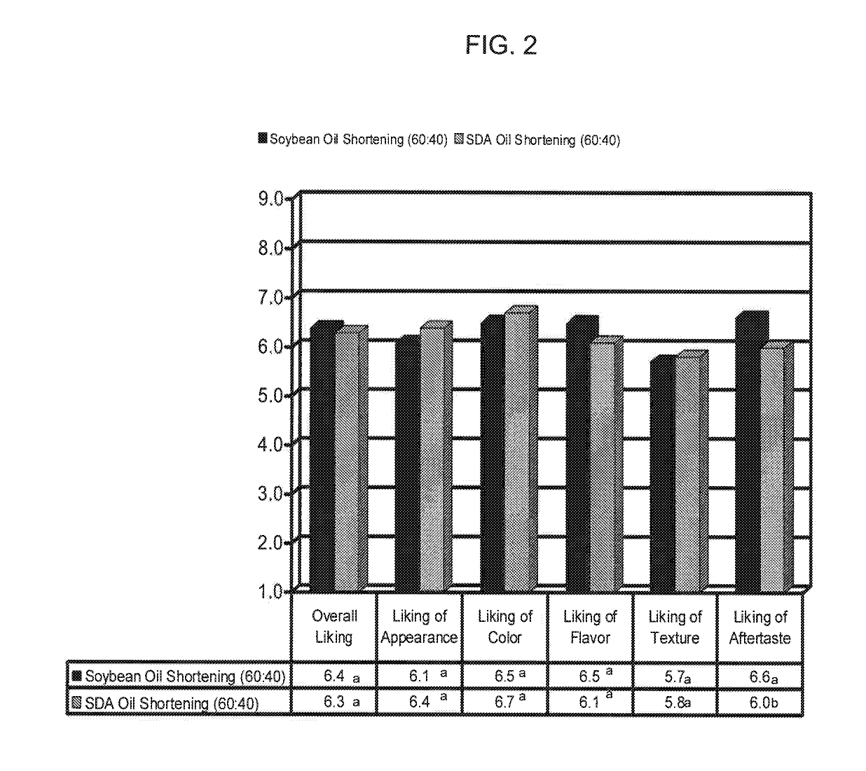

There were no significant differences in mean scores between Soybean Oil shortening (60:40) and SDA Oil shortening (60:40) in Overall Liking, Appearance Liking, Color Liking, Flavor Liking, and Texture Liking (FIG. 2).

The mean scores of Soybean Oil shortening (60:40) were significantly higher compared to SDA Oil shortening (60:40) in Aftertaste Liking (FIG. 2). However, the differences in Aftertaste Liking did not affect the Overall Liking.

### Example 6

### Dark Chocolate Compound Coating Bars Formulation

The following example relates to a method of forming a dark chocolate compound coating bar that contains an amount of SDA enriched shortening.

The dark chocolate compound coating bar was produced by placing an amount of a dark chocolate in a large bowl over simmering water and a temperature between 35° C.-38° C. (95° F.-100° F.). Table 13 provides detailed amounts of the ingredients. The amount of shortening was then added to the melted dark chocolate until all the shortening was melted and the temperature maintained at 38° C. (100° F.) for 5 minutes.

The mixture was then removed from the steam and stirred until a temperature of 32° C.-35° C. (90° F.-92° F.) was reached. The mixture was then poured into chocolate molds, tapped to remove dissolved air and placed in the refrigerator until hard, approximately 15 minutes, forming the dark chocolate compound coating bars.

TABLE 13
Dark Chocolate Compound Coating
Bars Formulation

| | | 80:20 SBO | 80:20 SDA |
|---|---|---|---|
| Ingredients | % | (g) | (g) |
| Chocolate | 88.9 | 1600.0 | 1600.0 |
| Shortening | 11.1 | 200.0 | 200.0 |
| Total | 100.0 | 1800.0 | 1800.0 |

The results were dark chocolate compound coating bars that have an increased amount of PUFA (omega-3), but retain the taste, structure, aroma, and mouthfeel of typical cookies currently on the market. The product delivers 220 mg to 531 mg of SDA per 45 g serving size of the dark chocolate compound coating bar (see Table 14).

Analyses of the dark chocolate compound coating bars were conducted with the results illustrated in Table 14. Gas chromatography was used to determine the fatty acid profiles for the shortening. Gas chromatography was conducted according to the AOCS Official Methods Ce 1-62 (1997), Ce 2-66, and Ce 1i-07 (2007).

TABLE 14
Fatty Acid Analysis of Dark Chocolate
Compound Coating Bars

| | 80:20 |
|---|---|
| | SDA |
| % Saturated Fat per 45 g serving size | 11.8 |
| % Monounsaturated Fat per 45 g serving size | 4.6 |
| % Polyunsaturated Fat per 45 g serving size | 1.1 |
| % Total n-3 PUFAs per 45 g serving size | 0.4 |
| % Total Omega-6 Fatty Acids per 45 g serving size | 0.8 |

### Example 7

### Sensory Profiling of Dark Chocolate Compound Coating Bars

Sensory descriptive analysis was conducted on dark chocolate compound coating bars to understand the attribute differences of Soybean Oil shortening and SDA Oil shortening in dark chocolate compound coating bars. Seven (7) panelists trained in the Sensory Spectrum™ Descriptive Profiling method evaluated the samples for 21 flavor attributes and 3 aftertaste attributes. The attributes were evaluated on a 15-point scale, with 0=none/not applicable and 15=very strong/high in each sample. Definitions of the flavor attributes are given in Table 15.

Each panelist was given two dark chocolate pieces and were instructed to take a bite and evaluate for flavor. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 15
Flavor Attribute Lexicon

| Attribute | Definition | References | |
|---|---|---|---|
| | | Intensities based on | |
| | | Universal Scale: | |
| | | Baking Soda in Saltme | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| Aromatics | | | |
| Overall Flavor Impact | The overall intensity of the product | | |
| | aromas, an amalgamation of all perceived | | |
| | aromatics, basic tastes and chemical | | |
| | feeling factors. | | |
| Chocolate Complex | The general category used to describe the | | |
| | aromatics associated with chocolate | | |
| Straw/hay/burlap | The aromatic associated with straw, hay | Straw or burlap bag | |
| | and burlap bags. | | |
| Dark roasted | The aromatic associated with dark | Dark roasted nuts, coffee | |
| | roasted nutmeat and having a very | grounds | |
| | browned or toasted characteristic | | |
| Alkali | The aromatic associated with alkalized | Baking cocoa mixed with baking | |
| | cocoa | soda | |
| Fat | The aromatic associated with the fat of | Cocoa butter | |
| | the cocoa bean | | |
| SWA Complex | The general category of aromatics | | |
| | associated with sweet foods. | | |
| Caramelized | The aromatics associated with browned | Caramelized sugar | |
| | sugars such as caramel. | | |
| Vanilla/vanillin | The aromatics associated with vanilla, | Vanilla Extract, Vanillin crystals | |
| | including artificial vanilla, woody, and | | |
| | browned notes. | | |
| Milky | The slightly sour, animal, milky aromatic | Skim Milk | |
| | associated with skim milk and milk | | |
| | derived products. | | |
| Cardboard/Woody | The aromatics associated with dried | Toothpicks, Water from | |
| | wood and the aromatics associated with | cardboard soaked for 1 hour | |
| | slightly oxidized fats and oils, | | |
| | reminiscent of a cardboard box. | | |
| Painty | The solvent aromatic associated with | Aroma of Linseed oil | |
| | linseed oils and moderately oxidized oil. | | |
| Fishy/Pondy Complex | The aroma/aromatics associated with | | |
| | triethylamine, pond water or aged fish. | | |
| | The general term used to describe fish | | |
| | meat, which cannot be tied to a specific | | |
| | fish by name. | | |
| Fishy | Aromatic associated with trimethylamine | Cod liver oil capsules, | |
| | and old fish. | trimethylamine, Geisha canned | |
| | | lump crab, oxidized tea bag, | |
| | | dried parsley, tuna in pouch | |
| Pondy | The aromas and aromatics associated | Algal oil (Martek 30% DHA oil) | |
| | with water containing algae, reminiscent | | |
| | of pond water and aquatic tanks. | | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

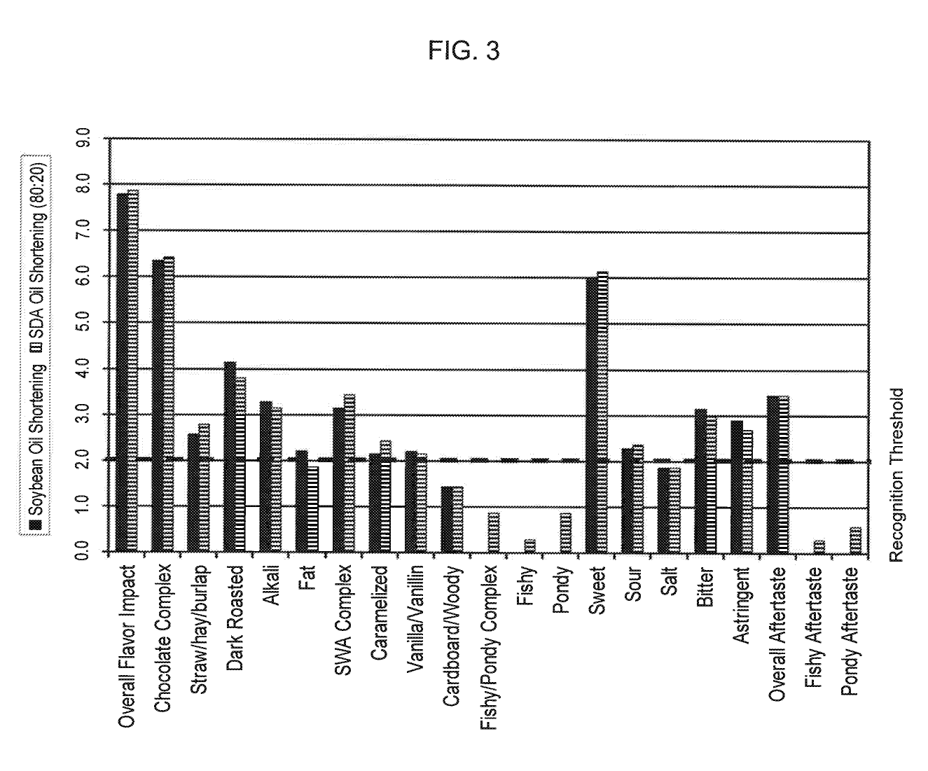

There were detectable differences between the Soybean Oil shortening (80:20) and SDA Oil shortening (80:20) in dark chocolate compound coating bars, shown in Table 16. The Soybean Oil shortening dark chocolate compound coating bar was higher in Dark Roasted aromatics, Fat aromatics, Bitter basic taste, and Astringent Feeling Factor (FIG. 3). This sample also had Butyric aromatics, Browned Fruit aromatics, Chemical aromatics, Ashy aromatics, and Earthy/Dirty aromatics, but no Fishy/Pondy aromatics or Fishy/Pondy Aftertaste.

The SDA Oil Shortening (80:20) dark chocolate compound coating bar was higher in Straw/Hay/Burlap aromatics, SWA Complex, Caramelized aromatics, Fishy/Pondy Complex, Pondy aromatics, and Pondy Aftertaste (FIG. 3). This sample also had Butyric aromatics, Browned Fruit aromatics, Chemical aromatics, and Ashy aromatics. The Fishy/Pondy aromatics were below the recognition threshold (2.0); therefore consumers could not detect these aromatics in this sample.

TABLE 16
Mean Scores for Flavor and Aftertaste
Attributes for Dark Chocolate

| | | SDA Oil | |
|---|---|---|---|
| | Soybean Oil | Shortening | p |
| | Shortening | (80:20) | value |
| Aromatics | | | |
| Overall Flavor Impact | 7.8 a | 7.9 a | NS |
| Chocolate Complex | 6.4 a | 6.4 a | * |
| Straw/hay/burlap | 2.6 b | 2.8 a | ** |
| Dark Roasted | 4.1 a | 3.8 b | *** |
| Alkali | 3.3 a | 3.1 a | NS |
| Fat | 2.2 a | 1.9 b | ** |
| SWA Complex | 3.1 b | 3.4 a | *** |
| Caramelized | 2.1 b | 2.4 a | *** |
| Vanilla/Vanillin | 2.2 a | 2.1 a | * |
| Milky | 0.0 | 0.0 | n/a |
| Cardboard/Woody | 1.4 a | 1.4 a | NS |
| Painty | 0.0 | 0.0 | n/a |
| Fishy/Pondy Complex | 0.0 c | 0.9 a | *** |
| Fishy | 0.0 b | 0.3 a | * |
| Pondy | 0.0 b | 0.9 a | *** |
| Other Aromatic: Butryic | 2.3 (86%) | 2.2 (43%) | |
| Other Aromatic: | 2.0 (29%) | 2.3 (29%) | |
| Browned Fruit | | | |
| Other Aromatic: | 2.3 (43%) | 2.3 (14%) | |
| Chemical | | | |
| Other Aromatic: Ashy | 2.0 (29%) | 2.0 (29%) | |
| Other Aromatic: | 2.0 (14%) | | |
| Earthy/Dirty | | | |
| Basic Tastes & Feeling | | | |
| Factors | | | |
| Sweet | 6.0 a | 6.1 a | NS |
| Sour | 2.3 a | 2.4 a | * |
| Salt | 1.9 a | 1.9 a | NS |
| Bitter | 3.1 a | 3.0 b | *** |
| Astringent | 2.9 a | 2.7 b | *** |
| Burn | 0.0 | 0.0 | n/a |
| Aftertaste | | | |
| Overall Aftertaste | 3.4 a | 3.4 a | NS |
| Fishy Aftertaste | 0.0 a | 0.3 a | * |
| Pondy Aftertaste | 0.0 b | 0.6 a | *** |

¹Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

### Example 8

### Sensory Acceptance of Dark Chocolate Compound Coating Bars

To evaluate sensory parity of Soybean Oil shortening and SDA Oil shortening, consumer acceptability based on Soybean Oil shortening and SDA Oil shortening were analyzed for dark chocolate. The acceptance ratings were compared between the Soybean Oil shortening and SDA Oil shortening dark chocolate.

The samples were evaluated by thirty-six (36) consumers willing to try dark chocolate; prescreened by signing the SDA informed consent. The judges used a 9-point Hedonic acceptance scale. The Hedonic scale ranged from 1 being dislike extremely to 9 being like extremely and was used for Overall Liking, Appearance Liking, Color Liking, Flavor Liking, Texture Liking, and Aftertaste Liking.

Consumers evaluated two dark chocolate pieces. The samples were served by sequential monadic presentation (one at a time).

The data were analyzed using the Analysis of Variance (ANOVA) to account for panelist and sample effects, with mean separations using Tukey's Significant Difference (HSD) Test.

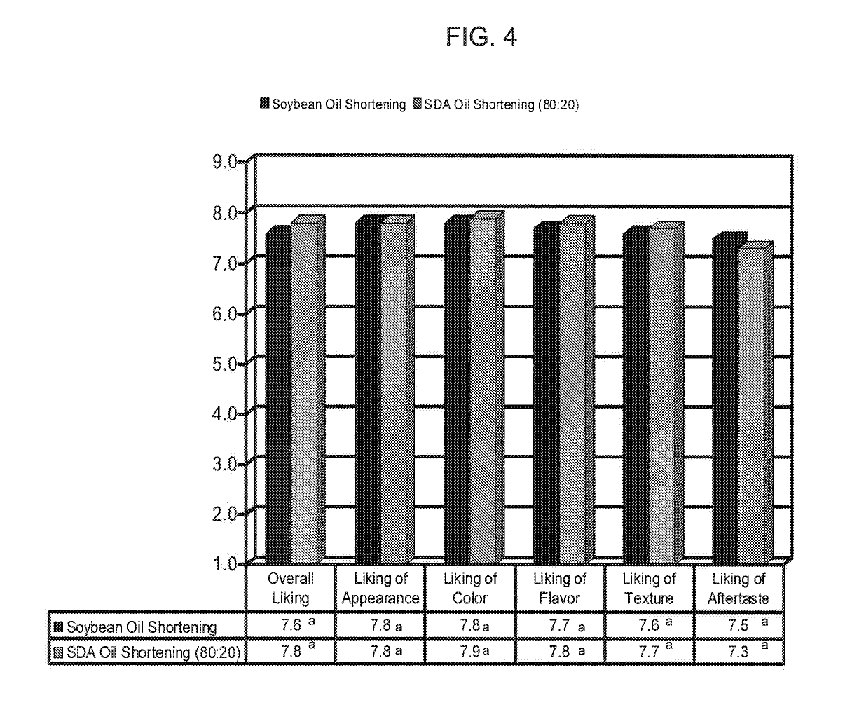

There were no significant differences between the Soybean Oil shortening and the SDA Oil shortening in Overall Liking, Appearance Liking, Color Liking, Flavor Liking, Texture Liking, and Aftertaste Liking (FIG. 4).

### Example 9

### Lemon Danish Pastry Formulation

The following example relates to a method of forming a pastry that contains an amount of SDA enriched shortening by incorporating 80:20 SDA shortening into the formulation.

Table 17 below provides the formulation.

All the dry ingredients were placed in a Hobart mixer and mixed for 1 minute using the dough hook attachment at speed #1.

The eggs were slightly beaten and slowly added to the bowl and mixed for 1 minute. The water, vanilla and color were added slowly and mixed for 2 minutes.

In a separate mixer, shortening blend and butter were mixed until smooth, approximately 5 minutes.

One third of the shortening butter mixture was added to the dough and slow mixed for 1 minute, after which the speed was increased to 2 and mixed for 10 minutes.

The dough was placed in a bread bowl, sealed and placed in the refrigerator to retard for 2 hours.

Laminating: The dough was rolled out into a rectangle. The remaining ⅔ of the shortening was spread over ⅔ of the length of the dough. The three fold methods was used to laminate. Dough was then retarded for 30 minutes. The folding, rolling and retarding were repeated two more times.

The dough was rolled out into a 2-4 mm (⅛ to 3/16 inch) thickness. The dough was cut into 7.6 cm (3 inch) squares. The corners of the squares were washed with water and folded in to form dough pieces.

The dough pieces were proofed at 35° C. (95° F.) and relative humidity of 85% for 40 minutes.

Lemon filling was added to the center of the dough pastries and the pastries were baked at 204° C. (400° F.) for 11 minutes.

The pastries were cooled for 10 minutes before packaging.

TABLE 17
Danish Pastry Formulation

| Ingredients | % Bakers | % Total | SBO (g) | SDA (g) |
|---|---|---|---|---|
| Bread Flour | 75.00 | 30.00 | 900.00 | 900.00 |
| Pastry Flour | 25.00 | 10.01 | 300.24 | 300.24 |
| Sugar | 14.00 | 5.60 | 168.04 | 168.04 |
| Salt | 1.75 | 0.70 | 21.06 | 21.06 |
| Sodium steroyl lactylate | 0.50 | 0.20 | 5.94 | 5.94 |
| Flavor (vanilla) | 2.50 | 0.99 | 29.69 | 29.69 |
| Butter Flavor | 0.50 | 0.24 | 7.20 | 7.20 |
| Nonfat dry milk | 4.00 | 1.60 | 47.95 | 47.95 |
| Eggs | 8.00 | 2.40 | 72.03 | 72.03 |
| Water (1.7° C. (35° F.)) | 51.30 | 20.53 | 615.74 | 615.74 |
| Yeast | 2.30 | 0.92 | 27.67 | 27.67 |
| Mono and Di Glycerides | 2.00 | 0.80 | 24.09 | 24.09 |
| Shortening Blends | 21.70 | 8.66 | 259.91 | 259.91 |
| Yellow color | 0.10 | 0.02 | 0.63 | 0.63 |
| Roll in shortening/butter | 43.30 | 17.33 | 519.81 | 519.81 |
| mix (based on flour weight) | | | | |
| Total | 251.95 | 100.00 | 3000.00 | 3000.00 |

### Example 10

### Sensory Profiling of Lemon Danish

Sensory descriptive analysis was conducted on lemon danishes to understand the attribute differences of Soybean Oil shortening and SDA Oil shortening in lemon danishes. Six (6) panelists trained in the Sensory Spectrum™ Descriptive Profiling method evaluated the samples for 20 flavor attributes and 3 aftertaste attributes. The attributes were evaluated on a 15-point scale, with 0=none/not applicable and 15=very strong/high in each sample. Definitions of the flavor attributes are given in Table 18.

Each panelist was given one Lemon Danish and instructed to take a bite. The samples were presented monadically in duplicate.

The data were analyzed using the Analysis of Variance (ANOVA) to test product and replication effects. When the ANOVA result was significant, multiple comparisons of means were performed using the Tukey's HSD West. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 18
Flavor Attribute Lexicon

| Attribute | Definition | Reference | |
|---|---|---|---|
| | | Intensities based on | |
| | | Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| AROMATICS | | | |
| Overall Flavor Impact | The overall intensity of the product aromas, an | | |
| | amalgamation of all perceived aromatics, basic | | |
| | tastes and chemical feeling factors. | | |
| Sweet Aromatics | The general category of aromatics associated | | |
| Complex | with sweet foods. | | |
| vanilla/vanillin | The aromatics associated with vanilla, including | Vanilla Extract, Vanillin | |
| | artificial vanilla, woody, and browned notes. | crystals | |
| caramelized | The aromatics associated with browned sugars | Caramelized sugar | |
| | such as caramel. | | |
| corn syrup | Flavor associated with products sweetened with | Dark Corn Syrup, Light | |
| | corn syrup. | corn syrup | |
| other | | | |
| Lemon | The sour citrus, slightly floral, peely aromatic | Lemon Oil | |
| | associated with lemon. | | |
| Grain/Toasted Grain | Aromatics associated with a nutty, caramelized, | Wheaties, Corn Flakes, | |
| | browned character of Maillard browned grains | toasted white bread | |
| | including corn, rice, and wheat. | | |
| Brown Spice | The sweet aromatic associated with cloves, | Cinnamon solution, | |
| | cinnamon, mace and nutmeg. | nutmeg solution | |
| Oil | The aromatics of unprocessed, uncooked fruits or | Vegetable Oil | |
| | vegetables or grain (not cooked) | | |
| Cardboard/Woody | The aromatics associated with dried wood and | Toothpicks, Water from | |
| | the aromatics associated with slightly oxidized | cardboard soaked for 1 | |
| | fats and oils, reminiscent of a cardboard box. | hour | |
| Eggy | The aromatics associated with boiled eggs. | Hard boiled eggs, freshly | |
| | boiled old-egg proteins or hydrogen sulfide gas. | peeled | |
| Fishy/Pondy Complex | The aroma/aromatics associated with | | |
| | triethylamine, pond water or aged fish. The | | |
| | general term used to describe fish meat, which | | |
| | cannot be tied to a specific fish by name. | | |
| Fishy | Aromatic associated with trimethylamine and old | Cod liver oil capsules, | |
| | fish. | trimethylamine, Geisha | |
| | | canned lump crab, tuna in | |
| | | pouch | |
| Pondy | The aromas and aromatics associated with water | Algal oil (Martek 30% | |
| | containing algae, reminiscent of pond water and | DHA oil) | |
| | aquatic tanks. | | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

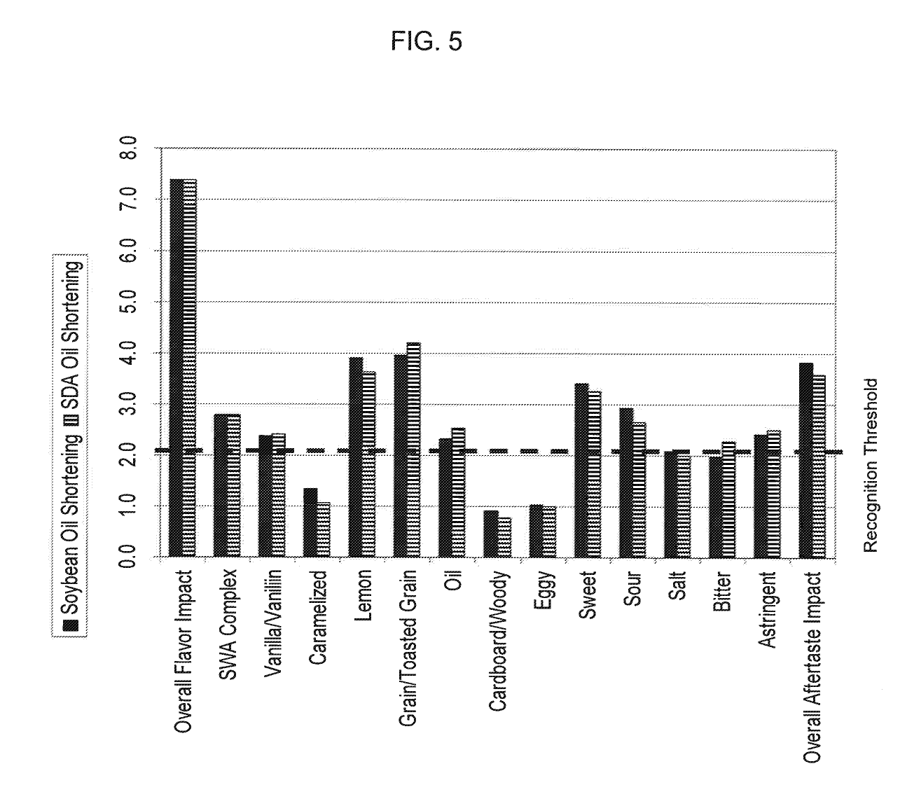

There were detectable differences between the Soybean Oil shortening and SDA Oil shortening lemon danish, shown in Table 19. The Soybean Oil shortening lemon danish was higher in Sour basic taste and did not have any Fishy/Pondy aromatics (FIG. 5).

The SDA Oil shortening lemon danish was higher in Oil aromatics and Bitter basic taste (FIG. 5). The SDA Oil shortening lemon danish also did not have any Fishy/Pondy aromatics.

TABLE 19
Mean Scores for Flavor and Aftertaste Attributes for
Lemon Danish

| | Soybean Oil | SDA Oil | | p |
|---|---|---|---|---|
| | Shortening | Shortening | HSD value | value |
| Aromatics | | | | |
| Overall Flavor Impact | 7.4 a | 7.4 a | 0.271 | NS |
| SWA Complex | 2.8 a | 2.8 a | 0.135 | NS |
| Vanilla/Vaniliin | 2.4 a | 2.4 a | 0.163 | NS |
| Caramelized | 1.4 a | 1.1 a | 0.532 | NS |
| Corn Syrup | 0.0 | 0.0 | n/a | n/a |
| Other SWA | 0.0 | 0.0 | n/a | n/a |
| Lemon | 3.9 a | 3.6 a | 0.458 | NS |
| Grain/Toasted Grain | 4.0 a | 4.2 a | 0.352 | NS |
| Brown Spice | 0.0 a | 0.2 a | 0.367 | NS |
| Oil | 2.3 b | 2.5 a | 0.163 | ** |
| Cardboard/Woody | 0.9 a | 0.8 a | 0.376 | NS |
| Eggy | 1.0 a | 1.0 a | 0.092 | NS |
| Fishy/Pondy Complex | 0.0 | 0.0 | n/a | n/a |
| Fishy | 0.0 | 0.0 | n/a | n/a |
| Pondy | 0.0 | 0.0 | n/a | n/a |
| Other: Chemical | 2.0 (17%) | 2.0 (17%) | | |
| Basic Tastes & | | | | |
| Feeling Factors | | | | |
| Sweet | 3.4 a | 3.3 a | 0.367 | NS |
| Sour | 2.9 a | 2.7 b | 0.284 | ** |
| Salt | 2.1 a | 2.0 a | 0.124 | NS |
| Bitter | 2.0 b | 2.3 a | 0.285 | ** |
| Astringent | 2.4 a | 2.5 a | 0.098 | NS |
| Burn | 0.3 a | 0.3 a | 0.183 | NS |
| Aftertaste | | | | |
| Overall Aftertaste Impact | 3.8 a | 3.6 a | 0.345 | NS |
| Fishy Aftertaste | 0.0 | 0.0 | n/a | n/a |
| Pondy Aftertaste | 0.0 | 0.0 | n/a | n/a |

Means in the same row, followed by the same letter are not significantly different at 95% Confidence.
*** 99% Confidence,
** 95% Confidence,
NS Not Significant
The attributes above threshold are bold. The attributes significant at 90% Confidence are italicized. For other attributes, % score is the percentage of times the attribute was perceived, and the score is reported as an average value of the detectors.

### Example 11

### Sensory Acceptance of Lemon Danish

To evaluate sensory parity of Soybean Oil shortening and SDA Oil shortening, consumer acceptability based on Soybean Oil shortening and SDA Oil shortening were analyzed for lemon danish. The acceptance ratings were compared between the Soybean Oil shortening and the SDA Oil shortening lemon danish.

The samples were evaluated by fifty (50) consumers willing to try lemon danish. The judges used a 9-point Hedonic acceptance scale. The Hedonic scale ranged from 1 being dislike extremely to 9 being like extremely and was used for Overall Liking, Appearance Liking, Color Liking, Flavor Liking, Texture Liking, and Aftertaste Liking.

Consumers evaluated one lemon danish. The samples were served by sequential monadic presentation (one at a time).

The data were analyzed using the Analysis of Variance (ANOVA) to account for panelist and sample effects, with mean separations using Tukey's Significant Difference (HSD) Test.

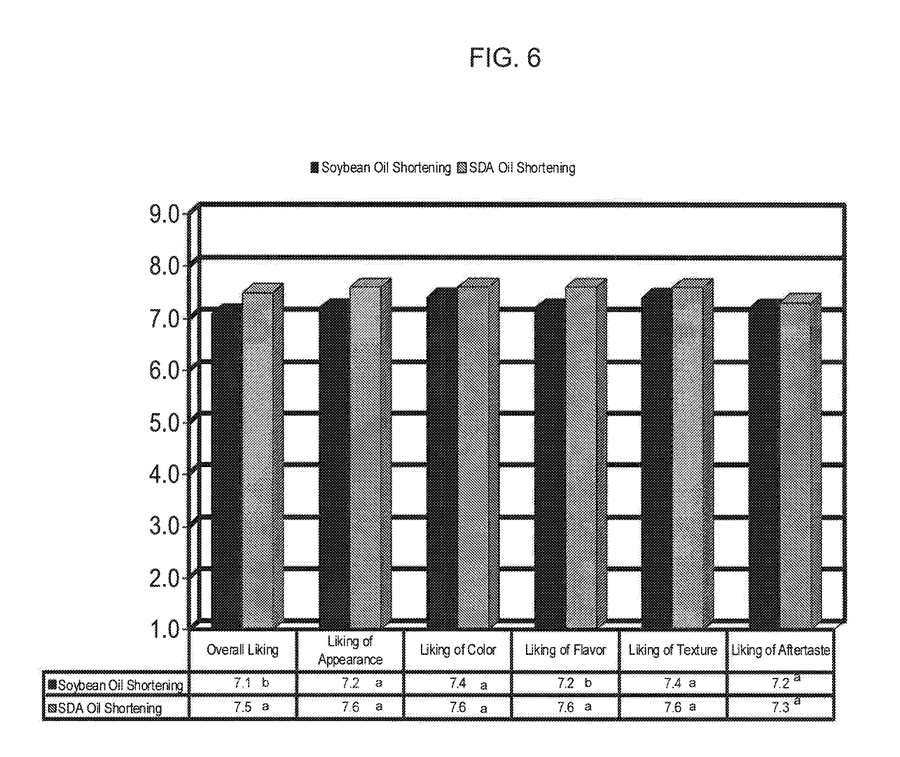

The mean scores of SDA Oil shortening lemon danish were significantly higher compared to Soybean Oil shortening lemon danish in Overall Liking and Flavor Liking (FIG. 6).

There were no significant differences between the mean scores of Soybean Oil shortening lemon danish and SDA Oil shortening lemon danish in Appearance Liking, Color Liking, Texture Liking, and Aftertaste Liking (FIG. 6).

### Example 12

### Vanilla Icing Formulation

The following example relates to a method of forming an icing that contains an amount of SDA enriched shortening by incorporating 40:60 SDA shortening into the formulation.

Water, lecithin, sodium stearoyl lactylate, and the shortenings were heated to 64° C. and mixed for 2 minutes to form a liquid mixture.

Vegetable shortening was placed in a bowl with the liquid mixture and the shortening and liquid mixture was mixed at slow speed for 5 minutes. Sugar was slowly added to the shortening and liquid mixture over 4 minutes while mixing at #1 speed and another 4 minutes at #2 speed. Vanilla and titanium dioxide were added and mixed in at speed #2 for 2 minutes. The vanilla icing was then packaged in sterile pudding cups.

Table 20 shows the formulation of the Vanilla icing.

TABLE 20
Vanilla Icing Formulation

| Ingredients | % | SBO (g) | SDA (g) |
|---|---|---|---|
| Powdered Sugar | 52.33 | 2773.49 | 2773.49 |
| Water | 6.54 | 346.62 | 346.62 |
| Lecithin Solec ™ F | 0.22 | 11.66 | 11.66 |
| Sodium Stearoyl Lactylate | 0.22 | 11.66 | 11.66 |
| Glycerin | 1.00 | 53.00 | 53.00 |
| Shortening blend | 11.12 | 589.36 | 589.36 |
| Vegetable shortening | 27.26 | 1444.78 | 1444.78 |
| Vanilla Flavor | 0.87 | 46.11 | 46.11 |
| Titanium Dioxide | 0.44 | 23.32 | 23.32 |
| Total | 100.00 | 5300.00 | 5300.00 |

### Example 13

### Sensory Profiling of Vanilla Icing

Sensory descriptive analysis was conducted on vanilla icing to understand the attribute differences of Soybean Oil shortening and SDA Oil shortening in vanilla icing. Nine (9) panelists trained in the Sensory Spectrum™ Descriptive Profiling method evaluated the samples for 21 flavor attributes and 3 aftertaste attributes. The attributes were evaluated on a 15-point scale, with 0=none/not applicable and 15=very strong/high in each sample. Definitions of the flavor attributes are given in Table 21.

Each panelist received approximately ounce of vanilla icing in 2 ounce cups with lids. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 21
Flavor Attribute Lexicon

| Attribute | Definition | Reference | |
|---|---|---|---|
| | | Intensities based on | |
| | | Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| Overall Flavor Intensity | The overall intensity of the product | | |
| | flavors, an amalgamation of all | | |
| | perceived flavors. | | |
| SWA Complex | The general category of aromatics | | |
| | associated with sweet foods. | | |
| Caramelized | The aromatics associated with browned | Caramelized sugar | |
| | sugars such as caramel. | | |
| Vanilla/vanillin | The aromatics associated with vanilla, | Vanilla Extract, Vanillin | |
| | including artificial vanilla, woody, and | crystals | |
| | browned notes. | | |
| Powder Sugar | The aromatics associated with | Powdered Sugar | |
| | powdered sugar. | | |
| Fat Complex | The general category of aromatics | | |
| | associated with fat. | | |
| Butter/Diacetyl | The clean, fatty, milky flavor of fresh | Sweet cream butter, | |
| | butter and/or artificial butter. | Diacetyl, Move-theater | |
| | | popcorn | |
| Shortening/Oil | The aromatics associated with partially | Vegetable oil, crisco | |
| | hydrogenated vegetable oil. | | |
| Cream Cheese Flavor | The aromatics associated with cream | Cream Cheese | |
| | cheese including natural and artificial | | |
| | flavoring. | | |
| Fishy/Pondy Complex | The aroma/aromatics associated with | | |
| | triethylamine, pond water or aged fish. | | |
| | The general term used to describe fish | | |
| | meat, which cannot be tied to a specific | | |
| | fish by name. | | |
| Fishy | Aromatic associated with | Temperature abused | |
| | trimethylamine and old fish. | mackerel | |
| | | Container of Cod fish oil | |
| | | supplements, tuna in pouch | |
| Pondy | The aromas and aromatics associated | Algal oil (Martek 30% DHA | |
| | with water containing algae, | oil) | |
| | reminiscent of pond water and aquatic | | |
| | tanks. | | |
| Cardboard/Woody | The aromatics associated with dried | Toothpicks, Water from | |
| | wood and the aromatics associated with | cardboard soaked for 1 hour | |
| | slightly oxidized fats and oils, | | |
| | reminiscent of a cardboard box. | | |
| Plastic | The aromatics associated with plastic | Glad plastic freezer bags | |
| | polyethylene containers or food stored | | |
| | in plastic; waxy, bitter, acidic, musty, | | |
| | pungent, smokey, or phenolic. | | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

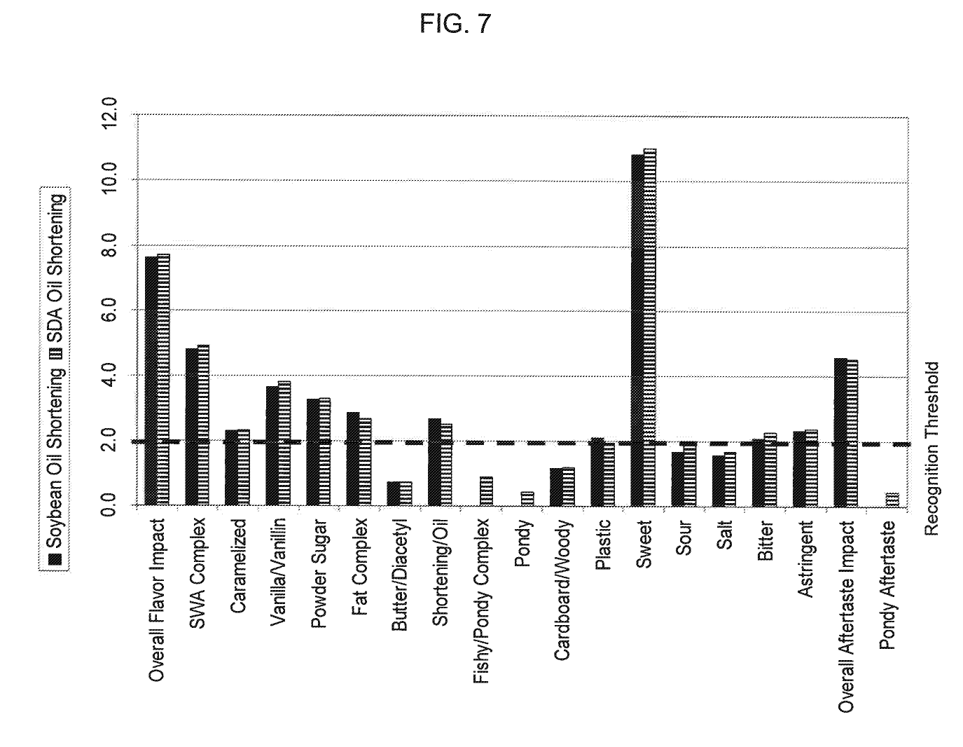

There were detectable differences between the Soybean Oil shortening and the SDA Oil shortening in vanilla icing, shown in Table 21. The Soybean Oil shortening vanilla icing was higher in Fat Complex and did not have any Fishy/Pondy aromatics (FIG. 7).

The SDA Oil shortening vanilla icing was higher in Fishy/Pondy Complex, Pondy aromatics, and Pondy Aftertaste (FIG. 7). The Fishy/Pondy aromatics are below the recognition threshold (2.0); therefore consumers could not detect these aromatics in this sample.

TABLE 22
Mean Scores for Flavor and Aftertaste Attributes for Vanilla Icing

| | Soybean Oil | SDA Oil | | p |
|---|---|---|---|---|
| | Shortenning | Shortening | HSD value | value |
| Aromatics | | | | |
| Overall Flavor Impact | 7.6 a | 7.7 a | 0.195 | NS |
| SWA Complex | 4.8 a | 4.9 a | 0.176 | NS |
| Caramelized | 2.3 a | 2.3 a | 0.059 | NS |
| Vanilla/Vanillin | 3.7 a | 3.8 a | 0.256 | NS |
| Other SWA | 0.0 | 0.0 | n/a | n/a |
| Powder Sugar | 3.3 a | 3.3 a | 0.160 | NS |
| Fat Complex | 2.9 a | 2.7 b | 0.148 | ** |
| Butter/Diacetyl | 0.7 | 0.7 | n/a | n/a |
| Shortening/Oil | 2.7 a | 2.5 a | 0.143 | * |
| Cream Cheese Flavor | 0.0 | 0.0 | n/a | n/a |
| Fishy/Pondy Complex | 0.0 b | 0.9 a | 0.508 | *** |
| Fishy | 0.0 | 0.0 | n/a | n/a |
| Pondy | 0.0 b | 0.4 a | 0.425 | ** |
| Cardboard/Woody | 1.2 a | 1.2 a | 0.262 | NS |
| Plastic | 2.1 a | 1.9 a | 0.341 | NS |
| Other: Fruity | 2.0 (6%) | 2.0 (33%) | | |
| Other: Burnt Sugar | | 2.0 (11%) | | |
| Basic Tastes & | | | | |
| Feeling Factors | | | | |
| Sweet | 10.8 a | 11.0 a | 0.271 | NS |
| Sour | 1.7 a | 1.9 a | 0.258 | NS |
| Salt | 1.6 a | 1.7 a | 0.182 | NS |
| Bitter | 2.1 a | 2.3 a | 0.211 | * |
| Astringent | 2.3 a | 2.4 a | 0.080 | NS |
| Burn | 0.8 b | 1.4 a | 0.413 | *** |
| Other FF: Slick/Waxy | 2.4 (67%) | 2.3 (67%) | | |
| Mouthcoating | | | | |
| Aftertaste | | | | |
| Overall Aftertaste Impact | 4.6 a | 4.5 a | 0.239 | NS |
| Fishy Aftertaste | 0.0 | 0.0 | n/a | n/a |
| Pondy Aftertaste | 0.0 b | 0.4 a | 0.425 | ** |

Means in the same row, followed by the same letter are not significantly different at 95% Confidence.
*** 99% Confidence,
** 95% Confidence,
NS Not Significant
The attributes above threshold are bold. The attributes significant at 90% Confidence are italicized. For other attributes, % score is the percentage of times the attribute was perceived, and the score is reported as an average value of the detectors.

### Example 14

### Sensory Acceptance of Vanilla Icing

To evaluate sensory parity of Soybean Oil shortening and SDA Oil shortening, consumer acceptability based on Soybean Oil shortening and SDA Oil shortening were analyzed of vanilla icing. The acceptance ratings were compared between the Soybean Oil shortening and the SDA Oil shortening vanilla icing.

The samples were evaluated by fifty (50) consumers willing to try vanilla icing. The judges used a 9-point Hedonic acceptance scale. The Hedonic scale ranged from 1 being dislike extremely to 9 being like extremely and was used for Overall Liking, Color Liking, Flavor Liking, Mouthfeel Liking, Thickness Liking, and Aftertaste Liking.

Consumers evaluated one (1) ounce of vanilla icing served in 2 ounce cups with lids. The samples were served by sequential monadic presentation (one at a time).

The data were analyzed using the Analysis of Variance (ANOVA) to account for panelist and sample effects, with mean separations using Tukey's Significant Difference (HSD) Test.

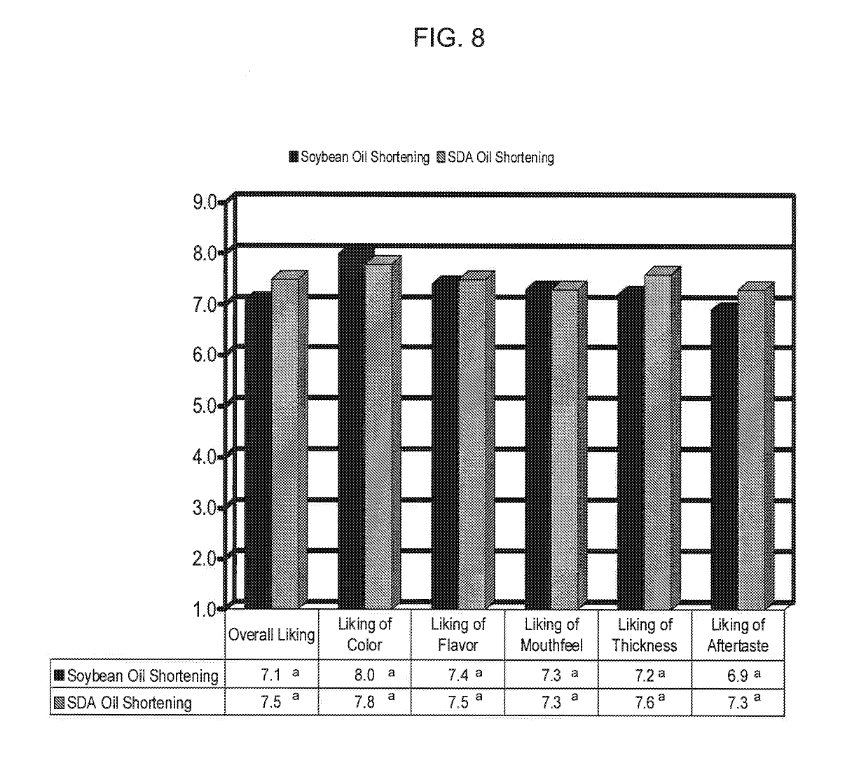

There were no significant differences between the mean scores of Soybean Oil shortening vanilla icing and SDA Oil shortening vanilla icing in Overall Liking, Color Liking, Flavor Liking, Mouthfeel Liking, Thickness Liking, and Aftertaste Liking (FIG. 8).

### Example 15

### Nut Butter Formulation

This refers to all types of butters prepared from nuts such as peanuts, almonds, walnuts, cacao, pine, pecans, pistachio, macadamia, cashew, Brazil and hazelnuts, Nut butters can also be dessert based such as chocolate based nut spreads.

In the manufacture of peanut butter, peanuts are ground to a size to pass through a 200-mesh screen. To improve smoothness, spreadability and flavor, other ingredients such as salt, hydrogenated vegetable oils, dextrose, corn syrup or honey are added. Ascorbic acid can also be added to enhance peanut butter's nutritive value. The quantities of these added ingredients must not exceed 10% of the peanut butter, according to the US standard of identity requirement for peanut butter to contain not more that 10% additional ingredients (21CFR Ch 1. §164.150 (2008)).

The first step in the production of peanut butter involves dry roasting of the peanuts by either continuous or batch process in a large ovens. The peanuts are heated to 160° C. (320° F.) until roasted which is determined by their moisture content. The roasted peanuts pass from the oven to a blower/cooler vat where they are cooled to 30° C. (86° F.) and are then passed through a gravity separator where all foreign materials are removed. The skins are then removed by water blanching at 137° C. (280° F.) for 20 minutes to remove the skin as well as the heart of the peanut which contains bitter components. The blanched peanuts are then air dried at 48° C. (120° F.) for 6 hours. The peanuts are then ground in a two step process until reduced to a paste with addition of salt, dextrose, stabilizer, and SDA oil shortening are added with thorough blending and the mixture is heated to 65° C. for 30 minutes. The peanut butter is cooled and packaged.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the claims.

1. A shortening composition having an amount of omega-3 fatty acids, wherein the shortening composition comprises:
a. a quantity of stearidonic acid; and,
b. at least one stabilizing agent.

2. The shortening composition of claim 1, wherein the at least one stabilizing agent is at least one antioxidant.

3. The shortening compositions of claim 1, wherein the shortening composition is selected from the group consisting of plastic shortening, liquid shortening, puff pastry shortening, puff pastry fats, dry shortenings, lards, and combinations thereof.

4. The shortening compositions of claim 1, wherein the stearidonic acid is a stearidonic enriched soybean oil.

5. The shortening compositions of claim 1, wherein the at least one stabilizing agent is selected from the group consisting of synthetic antioxidants, natural antioxidants, phospholipids, and combinations thereof.

6. The shortening compositions of claim 1, wherein the at least one stabilizing agent ranges between about 0.01% to about 65% by weight of the stearidonic acid.

7. A method of using stearidonic acid to form a shortening composition, wherein the method comprises adding
a. a quantity of stearidonic acid; and,
b. at least one stabilizing agent to the shortening composition.

8. The method of claim 7 wherein the stearidonic acid comprises between about 1% and about 95% of fat required in the shortening composition.

9. A food composition having a quantity of omega-3 fatty acids, wherein the composition comprises:
a. a quantity of stearidonic acid enriched shortening; and,
b. at least one stabilizing agent.

10. The food composition of claim 9, wherein the at least one stabilizing agent is at least one antioxidant.

11. The food compositions of claim 9, wherein the food composition is selected from the group consisting of baked food products, cookies, dough, pastries, breads, confections, margarines, butters, and combinations thereof.

12. The food compositions of claim 9, wherein the sensory characteristics of the food composition is comparable to the sensory characteristics of a food composition that does not contain stearidonic acid enriched shortening.

13. A nut butter having an amount of omega-3 fatty acids, wherein the nut butter comprises:
a. a quantity of stearidonic acid; and,
b. at least one stabilizing agent.

14. The nut butter of claim 13, wherein the at least one stabilizing agent is at least one antioxidant.

15. The nut butter of claim 13, wherein the nut butter is selected from the group consisting of peanut butter, almond butter, chocolate hazelnut spread, cashew butter, and combinations thereof.

16. The nut butter of claim 13, wherein the stearidonic acid is selected from the group consisting of stearidonic enriched soybean oil, stearidonic acid enriched soy flour, and combinations thereof.

17. The nut butter of claim 13, wherein the at least one stabilizing agent is selected from the group consisting of synthetic antioxidants, natural antioxidants, phospholipids, and combinations thereof.

18. A method of using stearidonic acid to form a nut butter, wherein the method comprises adding
a. A quantity of stearidonic acid; and,
b. at least one stabilizing agent to the nut butter.

19. The method of claim 18 wherein the stearidonic acid comprises between about 1% and about 95% of fat required in the nut butter.

20. A food composition having a quantity of omega-3 fatty acids, wherein the composition comprises:
a. a quantity of stearidonic acid enriched nut butter; and,
b. at least one stabilizing agent.
